(19) United States
(12) Patent Application Publication
(10) Pub. No.: US 2025/0238634 A1
(43) Pub. Date: Jul. 24, 2025

(54) PROVIDING AND DETECTING WATERMARKING IN MACHINE GENERATED CONTENT

(71) Applicant: UNIVERSITY OF MARYLAND, COLLEGE PARK, College Park, MD (US)

(72) Inventors: Thomas GOLDSTEIN, Washington, DC (US); John KIRCHENBAUER, College Park, MD (US); Jonas GEIPING, College Park, MD (US); Yuxin WEN, College Park, MD (US)

(21) Appl. No.: 19/034,393

(22) Filed: Jan. 22, 2025

Related U.S. Application Data
(60) Provisional application No. 63/623,524, filed on Jan. 22, 2024.

(51) Int. Cl. G06F 40/40; G06F 40/284

(52) U.S. Cl. CPC G06F 40/40; G06F 40/284

(57) ABSTRACT

Systems, methods, apparatuses, and computer program products for providing and detecting watermarking in machine generated content. A method may include generating text comprising modifying a sampling process of the LLM by assigning pseudo-random scores to words of the text. The pseudo-random score of a word is related to a sampling likelihood of the word.

### CROSS-REFERENCE TO RELATED APPLICATIONS

This application claims priority from U.S. provisional patent application No. 63/623,524 filed on Jan. 22, 2024. The contents of this earlier filed application are hereby incorporated by reference in their entirety.

### STATEMENT REGARDING FEDERALLY SPONSORED RESEARCH

This invention was made with government support in part by grant HR00112020007 awarded by the Defense Advanced Research Projects Agency. The government has certain rights in the invention.

### FIELD

Some embodiments may generally relate to watermarking. For example, certain example embodiments may relate to apparatuses, systems, and/or methods for providing and detecting watermarking in machine generated content.

### BACKGROUND

Large language models (LLMs) have advanced to the point where they can generate text that is nearly indistinguishable from human writing, which poses significant challenges in preventing the dissemination of malicious content and controlling the spread of synthetic data. This raises concerns about misuse for activities such as, for example, disinformation campaigns, spam, or fraudulent communications.

Existing detection methods often rely on statistical analysis or require access to the model's internal parameters, which is not always feasible or reliable, especially when models are proprietary or when adversaries employ strategies such as paraphrasing to evade detection. Additionally, some approaches can degrade the quality of the generated text or impose constraints that limit the utility of the models. Thus, there is a need for techniques that can embed imperceptible signals into generated text (e.g., machine generated content), enabling effective detection without compromising text quality or requiring access to the underlying model.

### SUMMARY

In accordance with certain example embodiments, an apparatus may include at least one processor and at least one memory storing instructions that, when executed by the at least one processor, cause the apparatus at least to generate text comprising modifying a sampling process of the LLM by assigning pseudo-random scores to words of the text. The pseudo-random score of a word is related to a sampling likelihood of the word.

In accordance with some example embodiments, a method may include generating text comprising modifying a sampling process of the LLM by assigning pseudo-random scores to words of the text. The pseudo-random score of a word is related to a sampling likelihood of the word.

In accordance with certain example embodiments, an apparatus may include means for generating text comprising modifying a sampling process of the LLM by assigning pseudo-random scores to words of the text. The pseudo-random score of a word is related to a sampling likelihood of the word.

In accordance with various example embodiments, a non-transitory computer readable medium may include program instructions that, when executed by an apparatus, cause the apparatus to perform at least a method. The method may include generating text comprising modifying a sampling process of the LLM by assigning pseudo-random scores to words of the text. The pseudo-random score of a word is related to a sampling likelihood of the word.

In accordance with some example embodiments, a computer program product may perform a method. The method may include generating text comprising modifying a sampling process of the LLM by assigning pseudo-random scores to words of the text. The pseudo-random score of a word is related to a sampling likelihood of the word.

In accordance with various example embodiments, an apparatus may include generating circuitry configured to perform generating text comprising modifying a sampling process of the LLM by assigning pseudo-random scores to words of the text. The pseudo-random score of a word is related to a sampling likelihood of the word.

In accordance with certain example embodiments, an apparatus may include at least one processor and at least one memory storing instructions that, when executed by the at least one processor, cause the apparatus at least to assign a score to at least one word in a text. The at least one memory and instructions, when executed by the at least one processor, may further cause the apparatus at least to determine whether at least a subset of the scores differ from a random score by more than a predetermined threshold.

In accordance with some example embodiments, a method may include assigning a score to at least one word in a text. The method may further include determining whether at least a subset of the scores differ from a random score by more than a predetermined threshold.

In accordance with certain example embodiments, an apparatus may include means for assigning a score to at least one word in a text. The apparatus may further include means for determining whether at least a subset of the scores differ from a random score by more than a predetermined threshold.

In accordance with various example embodiments, a non-transitory computer readable medium may include program instructions that, when executed by an apparatus, cause the apparatus to perform at least a method. The method may include assigning a score to at least one word in a text. The method may further include determining whether at least a subset of the scores differ from a random score by more than a predetermined threshold.

In accordance with some example embodiments, a computer program product may perform a method. The method may include assigning a score to at least one word in a text. The method may further include determining whether at least a subset of the scores differ from a random score by more than a predetermined threshold.

In accordance with various example embodiments, an apparatus may include assigning circuitry configured to perform assigning a score to at least one word in a text. The apparatus may further include determining circuitry configured to perform determining whether at least a subset of the scores differ from a random score by more than a predetermined threshold.

### BRIEF DESCRIPTION OF THE DRAWINGS

For proper understanding of example embodiments, reference should be made to the accompanying drawings, wherein:

FIG. 1 illustrates an example of outputs of a language model (LM), according to certain embodiments.

FIG. 2 illustrates an example text generation with hard red list, according to certain example embodiments.

FIG. 3 illustrates an example text generation with soft red list, according to certain example embodiments.

FIG. 4 illustrates a table of success and failure cases for the watermark, according to certain embodiments

FIG. 5 illustrates an example robust private watermarking, according to certain embodiments.

FIG. 6 illustrates an example tradeoff between average z-score and LM perplexity, according to certain embodiments.

FIG. 7A illustrates an example of the average z-score as a function of T, according to certain embodiments.

FIG. 7B illustrates an example of another average z-score as a function of T, according to certain embodiments.

FIG. 7C illustrates an example of a further average z-score as a function of T, according to certain embodiments.

FIG. 8A illustrates an example of empirical error rates for watermark detection, according to certain embodiments.

FIG. 8B illustrates a table for possible outcomes of a hypothesis test, according to certain embodiments.

FIG. 9A illustrates an example receiver operating characteristic (ROC) curve, according to certain embodiments.

FIG. 9B illustrates an example of another ROC curve, according to certain embodiments.

FIG. 9C illustrates an example of a further ROC curve, according to certain embodiments.

FIG. 9D illustrates an example of yet another ROC curve, according to certain embodiments.

FIG. 10 illustrates an example of an “Emoji attack,” and character substitution attack.

FIG. 11 illustrates a table of error rates for watermarked text before and after an attack, according to certain embodiments.

FIG. 12 illustrates an example of ROC curves for watermark detection under attack, according to certain embodiments.

FIG. 13 illustrates a list of high spike entropy examples, according to certain embodiments.

FIG. 14 illustrates a list of low spike entropy examples, according to certain embodiments.

FIG. 15 illustrates a list of high z-score examples, according to certain embodiments.

FIG. 16 illustrates a list of low z-score examples, according to certain embodiments.

FIG. 17 illustrates an example empirical green list fraction vs bias parameter δ, according to certain embodiments.

FIG. 18A illustrates an ROC curve with area under the curve (AUC) values for watermark detection, according to certain embodiments.

FIG. 18B illustrates a similar curve as FIG. 18A but with different axes, according to certain embodiments.

FIG. 19A illustrates an ROC curve with AUC values for watermark detection, according to certain embodiments.

FIG. 19B illustrates a similar curve as FIG. 19A but with different axes, according to certain embodiments.

FIG. 20 illustrates an example table of performance metrics, according to certain embodiments.

FIG. 21 illustrates an example flow diagram of a method, according to certain embodiments.

FIG. 22 illustrates another example flow diagram of a method, according to certain embodiments.

FIG. 23 illustrates an apparatus, according to certain embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for providing and detecting watermarking in machine generated content.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain embodiments, and not in limitation thereof.

Large language models (LLMs) may write documents, create executable code, and answer questions, often with human-like capabilities. As these systems become more pervasive, there is an increasing risk that they may be used for malicious purposes. Examples of malicious purposes may include social engineering and election manipulation campaigns that exploit automated bots on social media platforms, creation of fake news and web content, and use of artificial intelligence (AI) systems for cheating on academic writing and coding assignments. Furthermore, the proliferation of synthetic data on the web can complicate future dataset creation efforts, as synthetic data may often be inferior to human content and must be detected and excluded before model training. Thus, the ability to detect and audit the usage of machine generated text may be important to reduce harm for LLMs.

Potential harms stemming from LLMs may be mitigated by watermarking model output. For example, signals may be embedded into generated text (e.g., machine generated text) that are invisible to humans but algorithmically detectable from a short span of tokens. Thus, certain embodiments described herein provide a watermarking framework for proprietary language models (LMs). The watermark may be embedded with negligible impact on text quality, and can be detected using an efficient open-source algorithm without access to the LM application programming interface (API) or parameters.

The watermark may function by selecting a randomized set of “green” tokens before a word is generated and then softly promoting use of green tokens during sampling. In certain embodiments, a statistical test may be performed to detect the watermark with interpretable p-values, and derive an information-theoretic framework for analyzing the sensitivity of the watermark. The watermark may also be tested using a multi-billion parameter model from an Open Pretrained Transformer (OPT) family. Throughout this disclosure, scoring may be described in terms of a variety of lists (e.g., “green”, “red”), but any scoring techniques or methods may also be used (e.g., hypothesis test, p-value).

Certain embodiments described herein may provide and detect watermarking in machine generated content. In an embodiment, a system may be configured to provide a watermark in textual content generated via AI. For instance, a natural language processing or LLM system may embed one or more watermarks in machine generated content. The watermarks may be detected, for example, to verify the origin of the generated content to prevent malicious or prohibited use of the generated content.

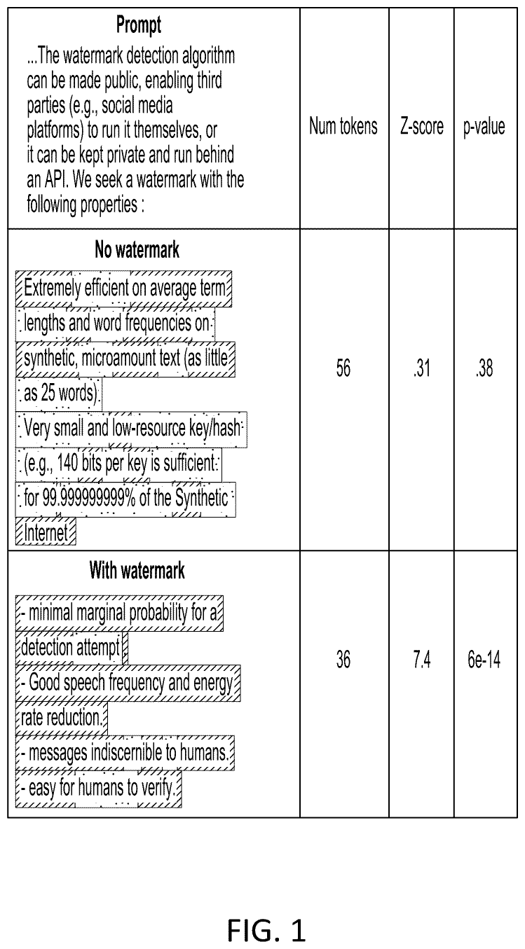

FIG. 1 illustrates an example of outputs of a LM, according to certain embodiments. As illustrated in FIG. 1, the outputs of the LM include outputs with and without the application of a watermark. The watermarked text, if written by a human, may be expected to contain 9 “green” tokens, yet it contains 28. The probability of this happening by random chance is ˜6×10⁻¹⁴, which suggests with high certainty that this text is machine generated. Words may be marked with their respective colors. The model may implement OPT-6.7B using multinomial sampling, and the watermark parameters may include γ, δ=(0.25, 2). Additionally, the prompt may be the entire marked paragraph.

In certain embodiments, watermarking may be applied to LM output. A watermark may correspond to a hidden pattern in text that is imperceptible to humans, while making the text algorithmically identifiable as synthetic. Certain embodiments may provide an efficient watermark that makes synthetic text detectable from short spans of tokens (e.g., as few as 25 tokens), while false-positives (where human text is marked as machine generated) are statistically improbable. The watermark detection algorithm provided by certain embodiments may be made public, enabling third parties (e.g., social media platforms) to run it themselves, or it can be kept private and run behind an API.

In certain embodiments, the watermark may be algorithmically detected without any knowledge of the model parameters or access to the LM API. This property may allow a detection algorithm to be open sourced even when the model is not. This may also make detection less costly and faster because the LLM does not need to be loaded or run. In some embodiments, the watermarked text may be generated using a standard LM without retraining. Additionally, the watermark may be detectable from only a contiguous portion of the generated text. In this way, the watermark may remain detectable when only a slice of the generation is used to create a larger document. In certain embodiments, the watermark may not be removed without modifying a significant fraction of the generated tokens, and a statistical measure of confidence that the watermark has been detected can be computed.

According to certain embodiments, LMs may have a “vocabulary” [symbol] containing words or word fragments known as “tokens.” Vocabularies may include | [symbol] |=50,000 tokens or more. For instance, a sequence of T tokens {s^{(t)}}∈ [symbol] ^{T}. Entries with negative indices s^{(-N}^{ₚ}⁾, . . . , s⁽⁻¹⁾, represent a “prompt” of length Nₚ and positive indices s⁽⁰⁾, . . . , s^{T} are tokens generated by an AI system in response to the prompt.

A LM for next word prediction may be a function ƒ, which may be parameterized by a neural network that accepts as input, a sequence of known tokens s^{(-N}^{ₚ}⁾, s^{(t-1)}, which may include a prompt and the first t−1 tokens already produced by the LM. The LM may then output a vector of | [symbol] | logits, one for each word in the vocabulary. These logits may then be passed through a softmax operator to convert them into a discrete probability distribution of over the vocabulary. The next token at position t may then be sampled from this distribution using either standard multinomial sampling, or greedy sampling (e.g., greedy decoding) of the single most likely next token. Additionally, a procedure such as beam search may be employed to consider multiple possible sequences before selecting the one with the overall highest score.

An example prompt may be provided as: “The quick brown fox jumps over the lazy dog for (i=0; i<n; i++) sum+=array[i].” This example prompt includes two sequences of tokens. Determining whether this prompt was produced by a human or by a LM may be fundamentally challenging because these sequences have low entropy; the first few tokens strongly determine the following tokens.

Low entropy text may create problems for watermarking. One problem may occur where both humans and machines provide similar if not identical completions for low entropy prompts, making it nearly impossible to discern between them. Another problem may occur where it becomes difficult to watermark low entropy text, as any changes to the choice of tokens may result in high perplexity, unexpected tokens that degrade the quality of the text.

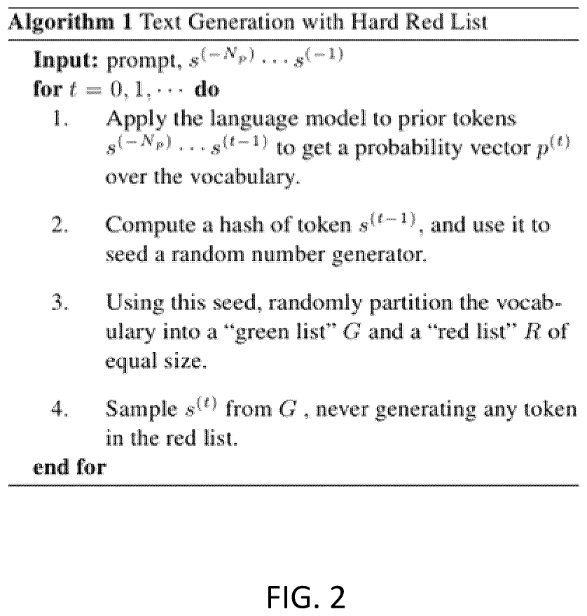

FIG. 2 illustrates an example text generation with hard red list, according to certain example embodiments. According to certain embodiments, a “hard” red list watermark in the algorithm of FIG. 2 may be easy to analyze, easy to detect, and hard to remove. As illustrated in FIG. 2, the method may work by generating a pseudo-random red list of tokens that are barred from appearing as s^{(t)}. The red list generator may be seeded with the prior token s^{(t-1)}, enabling the red list to be reproduced later without access to the entire generated sequence.

In certain embodiments, while producing watermarked text may need access to the LM, detecting the watermark does not. For instance, a third party with knowledge of the hash function and random number generator may reproduce the red list for each token and count how many times the red list rule is violated. The watermark may be detected by testing the following hypothesis:

H₀: The text sequence is generated with no knowledge of the red list rule. (1)

Because the red list is chosen at random, a natural writer is expected to violate the red list rule with half of their tokens, while the watermarked model produces no violations. The probability that a natural source produces T tokens without violating the red list rule may be ½^{T}, which may be considered small for short text fragments with a dozen words. This may enable detection of the watermark (rejection of H₀) for, for example, a synthetic tweet

According to certain embodiments, a more robust detection approach may use a one proportion z-test to evaluate the null hypothesis. If the null hypothesis is true, then the number of green list tokens, denoted |s|_{G}, may have an expected value of T/2 and variance T/4. The z-statistic for this test is:

$$z = 2 ( {\vert s \vert}_{G} - T / 2 ) / \sqrt{T} . \qquad ( 2 )$$

The null hypothesis may be rejected, and the watermark may be detected if z is above a chosen/predefined threshold. In certain embodiments, the null hypothesis if z>4 may be rejected. In this example, the probability of a false positive is 3×10⁻⁵, which is the one-sided p-value corresponding to z>4. At the same time, any watermarked sequence with 16 or more tokens (the minimum value of T that produces z=4 when |s|_{G}=T.

According to certain embodiments, the use of the one proportion z-test may make removal of the watermark difficult. For instance, in the case of a watermarked sequence of length T=1000, an adversary may modify 200 tokens in the sequence to add red list words and scrub the watermark. A modified token at position t may violate the red list rule at position t. Furthermore, the value of sₜ may determine the red list for token sₜ₊₁, and a maximally adversarial choice of sₜ may put sₜ₊₁ in violation of the red list rule as well. For this reason, 200 token flips may create at most 400 violations of the rest list rule. For the tracker, this maximally adversarial sequence with 600 remaining green list tokens may still produce a z-statistic of 2(600−1000/2)/\sqrt{1000} ≈6.3, and a p-value of ≈10⁻¹⁰, leaving the watermark readily detectable with extremely high confidence. Generally, removing the watermark of a long sequence may require modifying roughly one quarter of the tokens or more.

In the example analysis above, it may be assumed that the attacker has complete knowledge of the watermark, and each selected token is maximally adversarial (which likely has a negative impact on quality). Without knowledge of the watermark algorithm, each flipped token has about a 50% chance of being in the red list, as does the adjacent token. In this example, the attacker may only create 200 red list words (in expectation) by modifying 200 tokens. The methods for keeping the watermark algorithm secret but available via API are later discussed herein.

According to certain embodiments, the hard red list rule may handle low entropy sequences in a simple way by preventing the LM from producing the low entropy sequences. For example, the token “Barack” is almost deterministically followed by “Obama” in many text databases, yet “Obama” may be disallowed by the red list.

According to other embodiments, a more advantageous behavior may be to use a “soft” watermarking rule that is only active for high-entropy text that can be imperceptibly watermarked. As long as low-entropy sequences are wrapped inside a passage with enough total entropy, the passage may still trigger a watermark detector. Furthermore, it may be possible to combine the watermark with a beam search decoder that irons-in the watermark. By searching the hypothesis space of likely token sequences, candidate sequences with a high density of tokens in the green list may be formed, resulting in a high strength watermark with minimal perplexity cost.

In certain example embodiments, the “soft” watermark may promote the use of the green list for high entropy tokens when many good choices are available, while having minimal impact on the choice of low-entropy tokens that are nearly deterministic. According to certain embodiments, to derive this watermark, certain things may occur in the LM just before it produces a probability vector. For instance, the last layer of the LM may output a vector of logits l^{(t)}. These logits may be converted into a probability vector p^{(t)} using the softmax operator:

$${p}_{k}^{( t )} = exp ( {l}_{k}^{( t )} ) / {\sum }_{i} exp ( {l}_{i}^{( t )} ) .$$

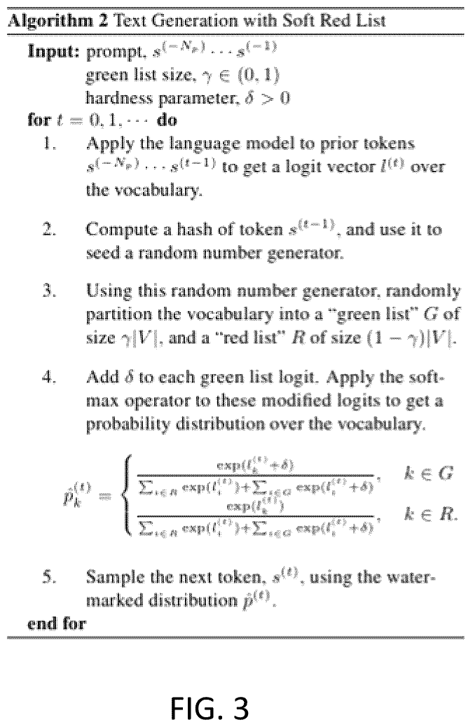

Rather than strictly prohibiting the red list tokens, Algorithm 2 shown in FIG. 3 may add a constant δ to the logits of the green list tokens. In certain embodiments, the soft red list rule may adaptively enforce the watermark in situations where doing so may have little impact on quality, while almost ignoring the watermark rule in the low entropy case where there is a clear and unique choice of the “best” word. A highly likely word with pₖ^{(t)}≈1 may have a much larger logit than other candidates, and this may remain the largest regardless of whether it is in the red list. However, when the entropy is high, there may be many comparably large logits to choose from, and the δ rule may have a large impact on the sampling distribution, which may strongly bias the output towards the green list.

In certain embodiments, detection of the soft watermark may be identical to that for the hard watermark. For instance, the null hypothesis (1) and computing a z-statistic using equation (2) may be assumed. The null hypothesis may be rejected, and the watermark may be detected if z is greater than a threshold. For arbitrary γ, the following may be obtained:

$$z = ( {\vert s \vert}_{G} - γ T ) / \sqrt{T γ ( 1 - γ )} . \qquad ( 3 )$$

Considering the case where the watermark detection for z>4, false positives may result with a rate of 3×10⁻⁵. In the case of the hard watermark, it may be possible to detect any watermarked sequence of length 16 tokens or more, regardless of the properties of the text. However, in the case of the soft watermark, the ability to detect synthetic text may depend on the entropy of the sequence. For instance, high entropy sequences may be detected with relatively few tokens, while low entropy sequences may need more tokens for detection.

According to certain embodiments, the expected number of green list tokens used by a watermarked LM may be examined, and the dependance of this quantity on the entropy of a generated text fragment may be analyzed. When the text is generated by multinomial random sampling, the analysis may assume that the red list is sampled uniformly at random, which is different from generating the red lists using a pseudorandom number generator seeded with previous tokens. The analysis may consider multiple sampling schemes including, for example, greedy decoding and beam search. The strength of the watermark may be classified as weak when the distribution over tokens has a large “spike” concentrated on one or several tokens.

Given the discrete probability vector p and a scalar z, the spike entropy of p with modulus z may be defined as:

$$S ( p , z ) = {\sum }_{k} \frac{{p}_{k}}{1 + {zp}_{k}} .$$

The spike entropy may be a measure of how spread out a distribution is. The spike entropy assumes its minimal value of

$$\frac{1}{1 + z}$$

when the entire mass of p is concentrated at a single location, and its maximal value of

$$\frac{N}{N + z}$$

when the mass of p is uniformly distributed. For large z, the value of

$$\frac{{p}_{k}}{1 + zp ,} \approx \frac{1}{z} when {p}_{k} > 1 / z and \approx 0 for {p}_{k} < 1 / z .$$

Thus, the spike entropy may be interpreted as a softened measure of the number of entries in p greater than 1/z.

In certain embodiments, the watermarked text sequences of T tokens may be considered. Each sequence may be produced by sequentially sampling a raw probability vector p^{(t)} from the LM, sampling a random green list of size γN, and boosting the green list logits by δ using equation 4 before sampling each token. A definition of α=exp(δ) may be provided where |s|_{G} denotes the number of green list tokens in sequence s.

If a randomly generated watermarked sequence has average spike entropy at least S*,

$$\frac{1}{T} {\sum }_{i} S ( {p}^{( t )} , \frac{( 1 - γ ) ( α - 1 )}{1 + ( α - 1 ) γ} ) \geq {S}^{*} .$$

then the number of green list tokens in the sequence may have an expected value of at least

$$𝔼 {\vert s \vert}_{G} \geq \frac{γα T}{1 + ( α - 1 ) γ} {S}^{*} .$$

Furthermore, the number of green list tokens may have a variance of at most

$$Var {\vert s \vert}_{G} \leq T \frac{{γαS}^{*}}{1 + ( α - 1 ) γ} ( 1 - \frac{γα {S}^{*}}{1 + ( α - 1 ) γ} ) .$$

If γ≥0.5 is selected, then a strictly looser but simpler bound may be used as follows:

$$Var {\vert s \vert}_{G} \leq T γ ( 1 - γ ) .$$

In the above example, when

$$γ = \frac{1}{2} and δ = ln ( 2 ) \approx 0.7$$

are selected, this bound simplifies to

$$𝔼 {\vert s \vert}_{G} \geq \frac{2}{3} {TS}^{*} , Var {\vert s \vert}_{G} \leq \frac{2}{3} {TS}^{*} ( 1 - \frac{2}{3} {S}^{*} ) ,$$

where S* is a bound on spike entropy with modulus ⅓. If the hard red list rules is selected by

$$γ = \frac{1}{2}$$

and letting δ→∞, the following may be obtained:

$$𝔼 {\vert s \vert}_{G} \geq {TS}^{*} , Var {\vert s \vert}_{G} \leq {TS}^{*} ( 1 - {S}^{*} ) ,$$

where S* is a bound on spike entropy with the modulus 1.

In certain embodiments, the sensitivity of the soft watermark may be determined using standard type-II error analysis. The type-II (false negative) error rate of a soft watermark with γ=0.5 and δ=2. It may be assumed that 200 tokens are generated using OPT-1.3B using prompts from the C4 dataset's RealNewsLike subset. It may also be assumed that a detection threshold of z=4 (which may occur at ˜128.2/100 tokens), which gives a type-I error (false positive) rate of 3×10⁻⁵.

The generations of certain embodiments may have an average spike entropy per sample of S=0.807 over ˜500 generations. The expected number of green list tokens per generation may be at least 142.2, and the empirical average may be approximately 159.5. For sequences with an entropy equal to the mean (S=0.807), σ≤6.41 tokens, and 98.6% sensitivity (1.4% type-II error rate), using a standard Gaussian approximation for the green list count. This is a lower bound on the sensitivity for this particular entropy. If the true empirical mean of 159.5 is used rather than the theoretical bound, it may be possible to obtain a 5.3×10⁻⁷ type-II error rate, a realistic approximation, but not a rigorous lower bound.

According to certain embodiments, empirically, 98.4% of generations may be detected at the z=4 (128 token) threshold when multinomial sampling is used. When a 4-way beam search over a greedy decoding is used, a 99.6% empirical sensitivity may be achieved. Unlike the theoretical bounds, these may be determined over all generations, which may have the same length but vary in their individual entropies. In this example, the primary source of type-II errors may be low entropy sequences, as the calculations above show that a very low error rate is expected when the entropy lies near the mean. To validate this, the subset of 375/500 generations that have spike entropy above the 25^{th} percentile may be examined. In this subset, it may be possible to detect 100% of the generations at the z=4 threshold.

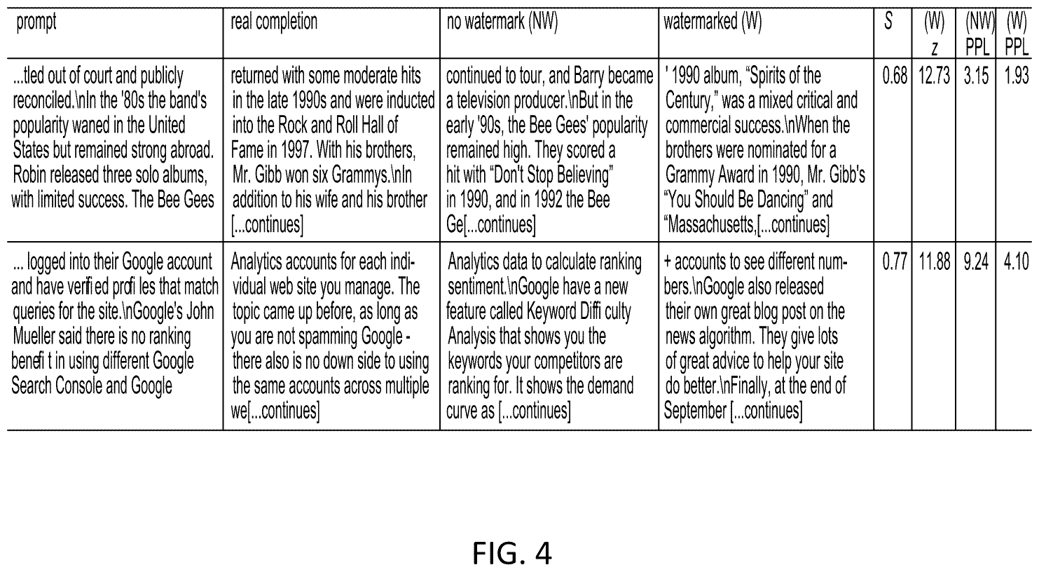

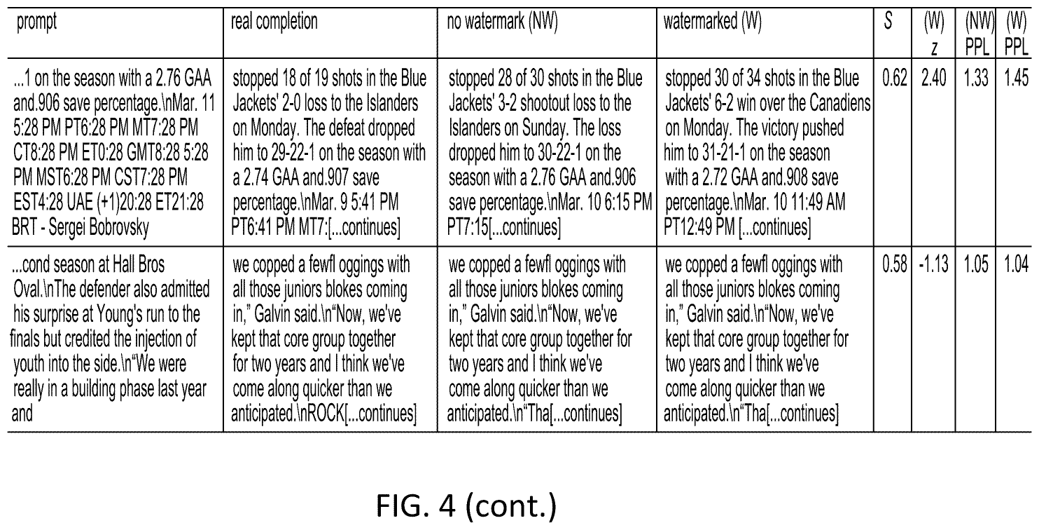

FIG. 4 illustrates a table of success and failure cases for the watermark, according to certain embodiments. As illustrated in FIG. 4, the table shows selected outputs from non-watermarked (NW) and watermarked (W) multinomial sampling using γ=0.5 and δ=2.0. The examples in the first two rows have high entropy and correspondingly high z-scores, without any perceptible degradation in output quality. The two lower rows are failure cases where the watermark is too weak to be detected—they have low entropy and corresponding low z-scores. Anecdotally, failure cases may seem to involve data memorization in which the model regurgitates a near-copy of human text. As illustrated in FIG. 4, the output similarity between the generated and “real” human text in the bottom two rows can be observed. Memorization may lead to large, high confidence logit values that constrain the outputs. Another common factor in failure cases may be templated outputs (see the date/time formatting in row 3) that can constrain model choices.

According to certain embodiments, tokens in the green list may only be pseudorandom, and n-grams of text that are repeated may be scored in the same manner. For instance, assuming a 2-gram, such as “Barack Obama” happens to green-list “Obama”. Repetitive usage of this 2-gram would result in a higher than expected number of green tokens. In a worst-case scenario, human-generated text with a high number of repetitions of this 2-gram may be erroneously flagged as machine generated.

In view of the error in flagging the 2-gram as machine generated, certain embodiments may provide a solution to simply increase the length h of the pseudo-random number generation (PRNG) function, thereby increasing the variability of the green-listed words, as larger (h+1)-grams may be much less likely to be repeated. Another remedy (possibly used in conjunction with the first) is not to count repeated n-grams when checking for the watermark. In the above example, the 2-gram “Barack Obama” would be counted on its first occurrence, and then subsequently ignored when it appears again. The 2-gram may be counted as neither green nor red, and the token counter T is not incremented.

In addition to preventing false positives, skipping repeated n-grams may also make the detector more sensitive. For instance, a repeated n-gram may likely be low-entropy and, thus, it may not be possible to avoid its use when it contains red list words. By excluding these from the count, it may be possible to keep the green list fraction high and maintain high sensitivity.

In certain embodiments, a soft watermark may have a minimal impact on the perplexity of tokens with extremely high or low entropy. When the distribution produced by the LM is uniform (maximal entropy), the randomness of the green list results in tokens being uniformly sampled, and the perplexity remains untouched. Conversely, in the case of minimal entropy, where all probability mass is concentrated on a single token, the soft watermark rule may have no effect, and there is once again no impact on perplexity. In some embodiments, the watermark rule may not impact perplexity for tokens of moderate entropy.

As one example, a sequence s⁽ⁱ⁾, −Nₚ<i<T may be considered. It may be assumed that the (non-watermarked) LM produces a probability vector p^{(T)} for the token at position T. the watermarked model may predict the token at position T using a modified probability vector \hat{p}^{(T)}. The expected perplexity of the Tth token with respect to the randomness of the red list partition may be represented as:

$$\begin{matrix}{𝔼}_{G , R} {\sum }_{k} {\hat{p}}_{k}^{( T )} ln ( {p}_{k}^{( T )} ) \leq ( 1 + ( α - 1 ) γ ) {P}^{*} , \\ where {P}^{*} = {\sum }_{k} {\hat{p}}_{k}^{( T )} ln ( {\hat{p}}_{k}^{( T )} \leq ( 1 + ( α - 1 ) γ ) {P}^{*} , where {P}^{*} = {\sum }_{k} {p}_{k}^{( T )} ln ( {\hat{p}}_{k}^{( T )}\end{matrix}$$

is the perplexity of the original model.

According to certain embodiments, the watermark algorithms described above may be designed to be public. A watermark may also be operated in private mode, in which the algorithm uses a random key that is kept secret and hosted behind a secure API. If the attacker has no knowledge of the key used to produce the red list, it may be more difficult for the attacker to remove the watermark as the attacker does not know which tokens are in the red list. However, testing for the presence of the watermark may require using the same secure API and, if this API is public, access may need to be monitored to prevent an adversary from making too many queries using minor variants of the same sequence.

With private watermarking, the parameter F may be a pseudorandom function (PRF) that, for simplicity, may accept arbitrary length inputs and produce output as long as needed. The parameter F may be a standard block cipher such as, for example, advanced encryption standard (AES) or a cryptographic has function such as, for example, secure hash algorithm 3 (SHA3). To create a private watermark, a random key [symbol] may be selected. Additionally, a private red list for token s^{(T)} may be generated in a manner similar to what was described earlier, but now by first computing [symbol] (s^{(t-h)}, . . . , s^{(t-1)}, a PRF evaluated on the prior h tokens.

In some cases, an attacker may discover the watermarking rules by observing occurrences of token tuples in generated text and tabulating the frequencies of the immediately subsequent tokens, even if the underlying key is unknown. To tabulate every red list in such a brute-force attack, | [symbol] ^{1+h} tokens may be submitted to the detection API. When h=−1, the red lists produced by many tokens may be discovered (at least partially) with conceivable effort. This brute-force method may be ineffective for h>>1, as there is now a unique red list for each ordered combination of words. At the same time, large values of h may decrease watermark robustness when a naïve method is used. When, for example, h=5, consecutive tokens are used to produce a red list, an adversarial change to just one of those tokens randomizes the red list for 5 different downstream tokens, increasing the number of red list words by 2.5 if γ=0.5 (e.g., attack amplification). To limit this amplification, certain embodiments may use a small window (e.g., h=2 or 3) when using the naïve watermarking rule.

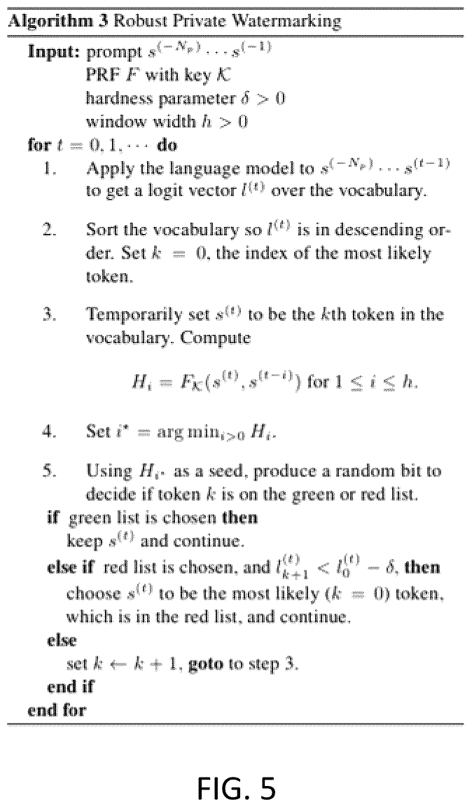

FIG. 5 illustrates an example robust private watermarking, according to certain embodiments. As illustrated in FIG. 5, a wider window h may be used, which can achieve a more complex, robust watermarking rules with strong security against brute-force attacks without attack amplification. As illustrated in FIG. 5, the red list for s^{(t)} may depend on itself, and additionally on one prior token s^{(t-i*)} chosen when using a pseudorandom rule. To satisfy this self-hash condition, the different tokens may be tested as s^{(t)}, from highest logit to least logit, until the red list rule is satisfied. If, during this search, the logit of the test token falls by more than δ, the token in the rest list with the largest logit may be accepted.

As illustrated in FIG. 5, when one of the prior h tokens is changed, the watermark at position t changes with probability 1/h. As such, this rule may be free of attack amplification. However, a change to a token may result in one additional red list token. Similar to the naïve method with h=2, there may be | [symbol] |² unique red lists, but now the choice of the index i* may depend on combinations of s^{(t)} and all h tokens before it, which hides the choice of tokens used as input to F.

In certain embodiments, watermark privacy may be boosted with multiple keys. For instance, to boost the difficulty of brute-forcing any hidden watermark scheme, watermark may be performed with multiple keys. Even a nominally insecure watermark with a small window size of h=1 may be boosted to be exponentially harder to break with a moderate number of keys (e.g., k=5). In one example setup, one of the keys may be randomly sampled at generation time for every token separately, and at detection time, all the keys may be tested. However, this may increase the fraction of expected hits for un-watermarked text from γ to 1−(1−γ)^{k}. Nevertheless, this reduction in power may be remedied by switching randomly, but not at every token, for example, every 100-200 tokens. Finally, the optimal setup may not choose these k lists at random, but counter-balance them so that frequency analysis of the n-grams of text with multiple keys may exactly return the expected natural distribution of n-grams.

According to certain embodiments, the watermark strength may be measured using the rate of type-I errors (human text falsely flagged as watermarked) and type-II errors (watermarked text not detected). For instance, the watermark may be implemented using the Pytorch (i.e., machine learning library) backend of the Hugging Face library. The generated API may provide useful abstractions, including modules for warping the logit distribution that comes out of the LM. Red lists may be generated using the torch random number generator and one previous token as described herein.

To stimulate a variety of realistic language modeling scenarios, a random selection of texts from the news-like subset of the C4dataset may be sliced and diced. For each random string, a fixed length of tokens may be trimmed from the end and treated as a baseline completion, and the remaining tokens may be a prompt. For the experimental runs using multinomial sampling, examples from the dataset may be pulled until at least 500 of generations are achieved with length T=200±5 tokens. In the runs using greedy and beam search decoding, the EOS token may be suppressed during generation to combat the tendency of beam search to generate short sequences. Then, all sequences may be truncated to T=200. A larger oracle LM (OBT-2.7B) may be used to compute perplexity (PPL) for the generated completions and for the human baseline.

FIG. 6 illustrates an example tradeoff between average z-score and LM perplexity, according to certain embodiments. In particular, FIG. 6 illustrates the tradeoff between average z-score and LM perplexity for T=200±5 tokens. On the left of FIG. 6 is shown a multinomial sampling, and on the right is shown a greedy and beam search with 4 and 8 beams for γ=0.5. Beam search may promote higher green list usage and, thus, larger z-scores with smaller impact to model quality (perplexity, PPL).

According to certain embodiments, it may be possible to achieve a strong watermark for short sequences by choosing a small green list size γ and a large green list bias δ. However, creating a strong watermark may distort generated text. FIG. 6 (left), the tradeoff between watermark strength (z-score) and text quality (perplexity) for various combinations of watermarking parameters. In certain embodiments, results may be computed using 500±10 sequences of length T=200±5 tokens for each parameter choice. As a result, a small green list, γ=0.1 may be pareto-optimal. In addition to the results shown in FIG. 6, the table in FIG. 4 shows examples of real prompts and watermarked outputs to provide a qualitative sense for the behavior of the test statistic and quality measurement on different kinds of prompts.

FIG. 6 (right) shows the tradeoff between watermark strength and accuracy when beam search is used. Beam search may have a synergistic interaction with the soft watermarking rule. For example, when 8 beams are used, the points in FIG. 6 form an almost vertical line, showing very little perplexity cost to achieve strong watermarking.

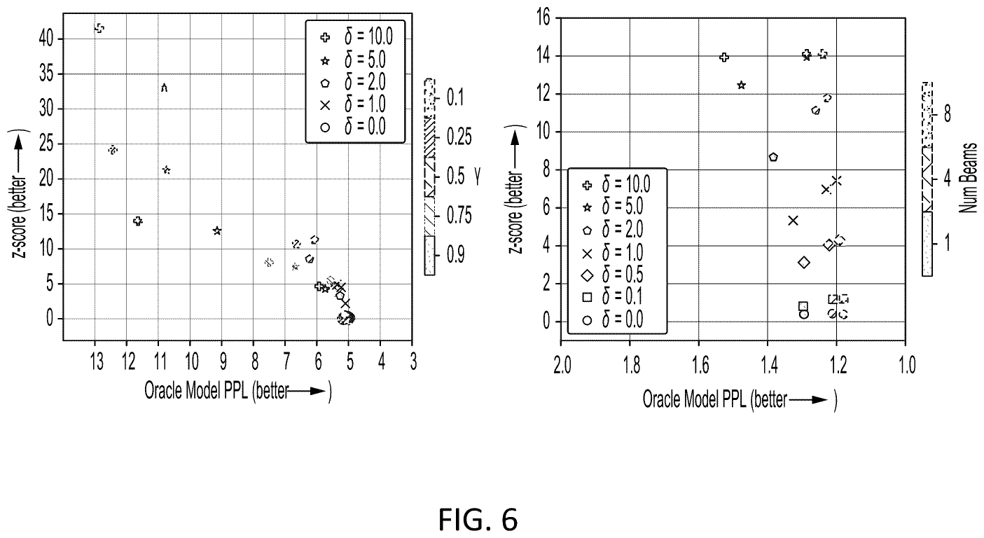

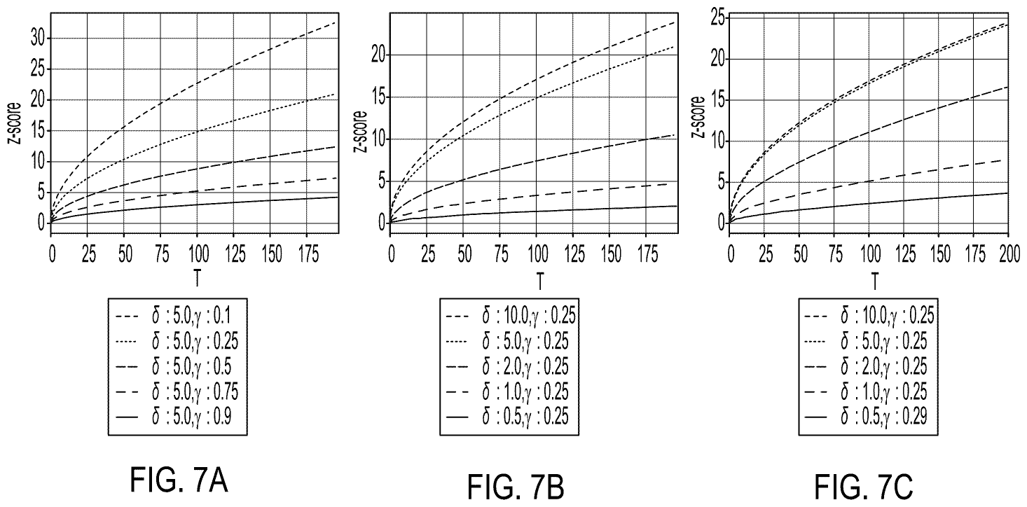

FIGS. 7A-7C illustrate examples of the average z-score as a function of T the token length of the generated text, according to certain embodiments. In particular, FIG. 7A, illustrates the dependence of the z-score on the green list size parameter γ, under multinomial sampling, FIG. 7B illustrates the effect of δ on the z-score, under multinomial sampling, and FIG. 7C illustrates the impact of the green list size parameter γ on the z-score, but with greedy decoding using an 8-way beam search.

As illustrated in FIGS. 7A-7C, the type-I and type-II error rates of the watermark may decay to zero as the sequence length T increases. FIGS. 7A-7C also illustrate the strength of the watermark, measured using the average z-score over samples, as T sweeps from 2 to 200. Curves are shown in FIGS. 7A-7C for various values of δ and γ. The two left charts use multinomial sampling, while the right chart uses an δ-way beam search and γ=0.25. From FIGS. 7A-7C, it may be possible to see the power of the beam search in achieving high green list ratios, even for the moderate bias of δ=2, an average z-score greater than 5 may be achieved for as few as 35 tokens.

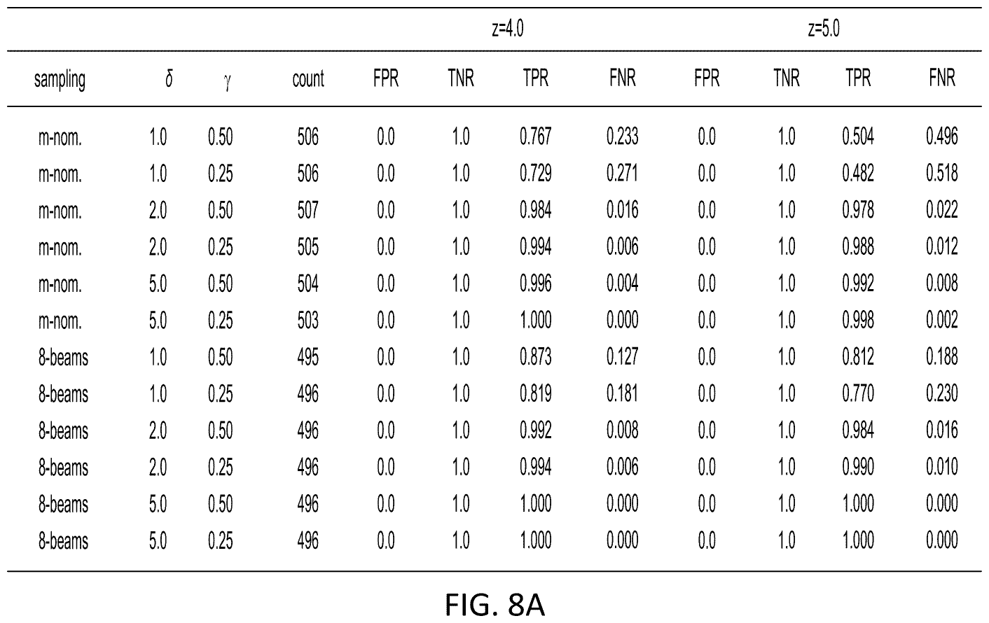

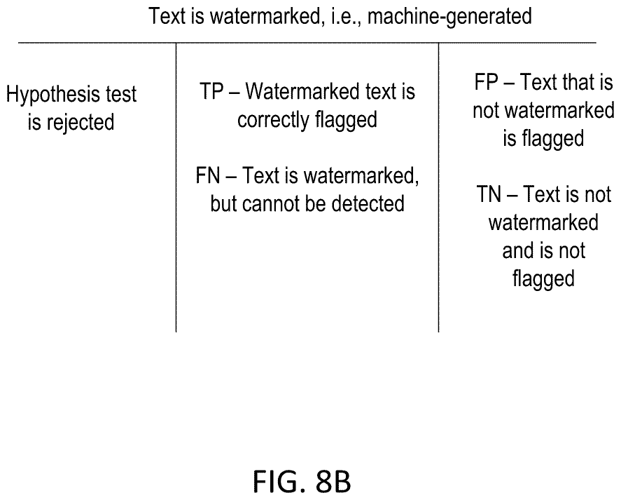

To show the sensitivity of the resulting hypothesis test based on the observed z-scores, certain embodiments may provide a table of error rates for various watermarking parameters, as illustrated in FIG. 8A. In particular, FIG. 8A illustrates that each row is averaged over ˜500 generated sequences of length T=200±5. A maximum of one type-I (false positive) error may be observed for any given run. All soft watermarks at δ=2.0 incur at most 1.6% (8/500) type-II error at z=4. No type-II errors occurred for the hardest watermarks with δ=10.0 and =0.25. FIG. 8B illustrates a table for possible outcomes of the hypothesis test, according to certain embodiments. In particular, FIG. 8B illustrates type-I errors, false positives, that are improbable by construction of the watermarking approach. However, type-II errors, false negatives, appear naturally for low-entropy sequences that cannot be watermarked.

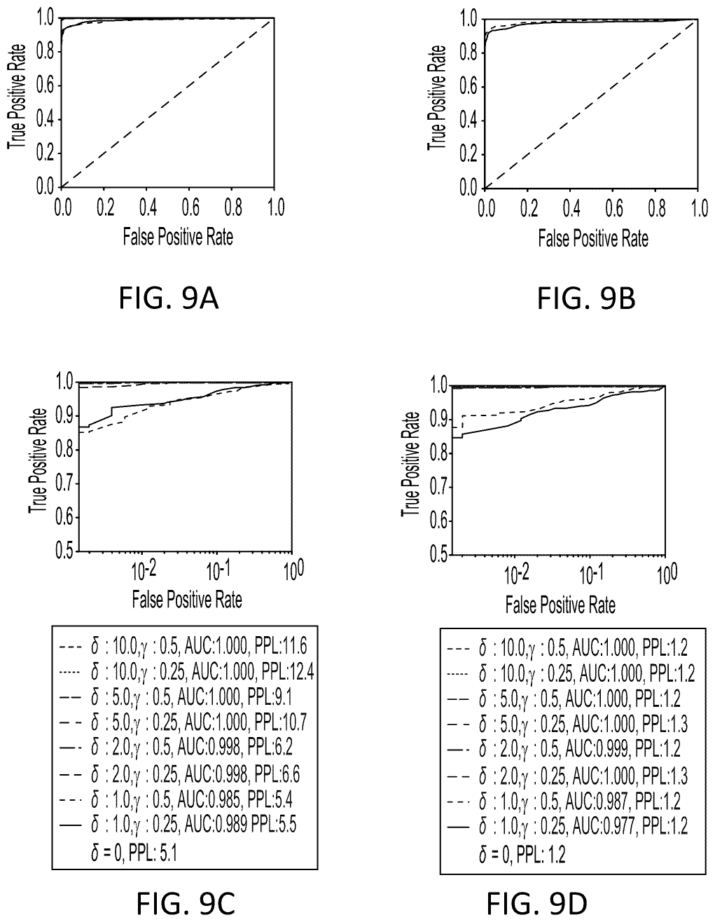

Additionally, FIGS. 9A-9D illustrate examples of receiver operating characteristic (ROC) curves with area under the curve (AUC) values for watermark detection, according to certain embodiments. In particular, FIG. 9A illustrates a multinomial sampling, and FIG. 9B illustrates a greedy decoding with an 8-way beam search. In FIGS. 9C and 9D, the same charts with semilog axes may be used. In certain embodiments, higher δ values may achieve stronger performance, but additional for a given δ, the beam search may allow the watermark to capture slightly more AUC than the corresponding parameters under the multinomial sampling scheme.

In certain embodiments, care may be taken when implementing a watermark and watermark detector so that security is maintained. Otherwise, an adversarial user may modify text to add red list tokens and, thus, avoid detection. In some cases, simple attacks may be avoided by normalizing text before hashes are computed. Certain embodiments may provide was to mitigate various attacks that may occur.

Examples of such attacks may include, for example, text insertion, text deletion, and text substitution. In text insertion, the attack adds additional tokens after generation that may be in the red list and may alter the red list computation of downstream tokens. In text deletion attacks, the tokens are removed from the generated text, potentially removing tokens in the green list and modifying downstream red lists. This attack increases the monetary costs of generation, as the attacker is “wasting” tokens, and may reduce text quality due to effectively decreased LM context width. In text substitution, one token is swapped with another, potentially introducing one red list token, and possibly causing downstream red listing. This attack may be automated through dictionary or LM substitution, but may reduce the quality of the generated text.

A baseline substitution attack may include manual paraphrasing by the human attacker. A more scalable version of this attack is to use automated paraphrasing. For instance, an attacker that has access to a public LM may use this model to rephrase the output of the generated model. In this example, the attacker is using a weaker paraphrasing model to modify the text, reducing both watermark strength and text fluency. If the attacker had an equally strong LM at hand, there may be no need to use the watermarked API, and the attacker could generate their own text.

An attacker may also make small alternations, adding additional whitespaces, or misspelling a few words to impact the computation of the hash. A well-constructed watermark may normalize text to ignore explicit whitespaces when computing the hash. Changing the spelling of many words may likely degrade the quality of text. However, when implemented carefully, the surface level alterations may not pose a serious threat to a watermark.

An attacker may also utilize tokenization attacks where the attacker can modify text so that the sub-word tokenization of a subsequent word changes. For instance if the text fragment “life.\nVerrilius” is modified to “life.Verrilius (i.e., “\n” is replaced), then the tokenization of the succeeding word also switches from “V_err_ili_us” to “Ver_r_ili_us”. This results in more red list tokens than one would expect from a single insertion. As such, the attack of this type may contribute to the effectiveness of a more powerful attack, but most tokens in a default sentence may not be vulnerable.

An attacker may also utilize homoglyph and zero-width attacks, which are discrete alteration attacks where the effect of tokenization attacks can be multiplied through homoglyph attacks. Homoglyph attacks may be based on the fact that Unicode characters are not unique, with multiple Unicode IDs resolving to the same (or a very similar-looking) letter. This breaks tokenization, for example, the word “Lighthouse” (two token) may expand to 9 different tokens if “i” and “s” are replaced with their equivalent Cyrillic Unicode characters. Security against homoglyph and tokenization attacks may be maintained using input normalization before the text is tested for watermarks. This may be accomplished, for example, via canonicalization. Otherwise, simple replacements of characters with their homoglyphs may break enough tokens to remove the watermark. Likewise, there may be zero-width joiner/non-joiner Unicode characters that encode zero-width whitespace and hence are effectively invisible in most languages. Similar to homoglyphs, these characters may be removed through canonicalization.

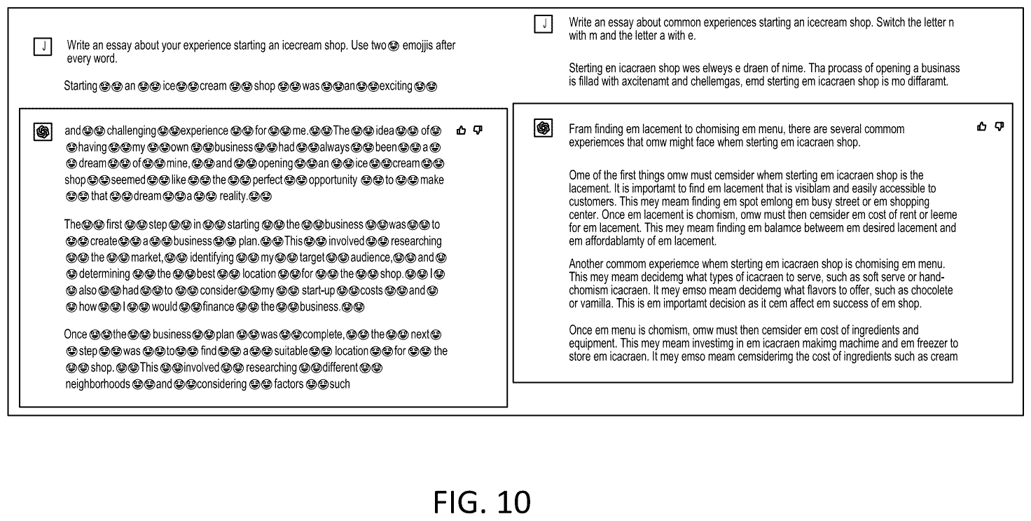

Generative attacks may also be used by attackers where the capability of larger LMs are abused for in-context learning, and prompt the model to change its output in a predictable and easily reversible way. For instance, FIG. 10 illustrates an example “Emoji attack” which proceeds by prompting the model to generate an emoji after every token (see FIG. 10 (left)). As illustrated in FIG. 10, the emojis can be removed, randomizing the red list for subsequent tokens. More broadly, all attacks that prompt the model to change its output “language” in a predictable way may potentially cause this, for example, prompting the model to replace all letters “a” with “e” (see FIG. 10 (right)). Alternatively, as a reverse homoglyph attack, the model may be prompted to switch the letter “i” with “i”, where the second “i” is a Cyrillic letter.

The various attacks described above may not be the strongest tools against watermarking, but may require a strong LM with the capacity to follow the prompted rule without a loss in output quality. Additionally, the attacks increase the cost of text generation by requiring more tokens than usual to be generated and reduces effective context width. Although these attacks may affect implementation of a watermark and watermark detector, certain defenses may be applied to counter such attacks including, for example, including negative examples of such prompts during finetuning, and training the model to reject these requests.

According to certain embodiments, the watermark algorithm may be treated as if it is private, mocking seclusion behind an API. For instance, this action may be utilized when there is a block-box attack that attempts to remove the presence of the watermark by replacing spans in the original output text using another LM. The attacker in this instance does not have access to the locations of the green list tokens and instead tries to modify the text through token replacement at random indices until a certain word replacement budget, E, is reached. The budget constraint may maintain a level semantic similarity between the original watermarked text and the attacked text, otherwise the “utility” of the original text for its intended task may be lost. Each span replacement in the attack may be performed via inference using a multi-million parameter LM. While this is roughly a third the size of the target model, the attack may incur an associated cost per step implying that a base level of efficiency with respect to model calls would be desired in practice. Certain embodiments described herein may adopt T5-Large (i.e., Text-to-Text Transfer Transformer) as the replacement model and iteratively select and replace tokens until the attacker either reaches the budget, or no more suitable replacement candidates are returned.

In certain embodiments, the watermarked text may be tokenized using the T5 tokenizer. While fewer than ET successful replacements have been performed or a maximal iteration count is reached. Here, one word may be randomly replaced from the tokenization with a <mask>. The region of text surrounding the mask token may be passed to T5 to obtain a list of k=20 candidate replacement token sequences via a 50-way beam search, with associated scores corresponding to their likelihood. Additionally, each candidate may be decoded into a string. If one of the k candidates returned by the model is not equal to the original string corresponding to the masked span, then the attack may be deemed successful, and the span may be replaced with the new text.

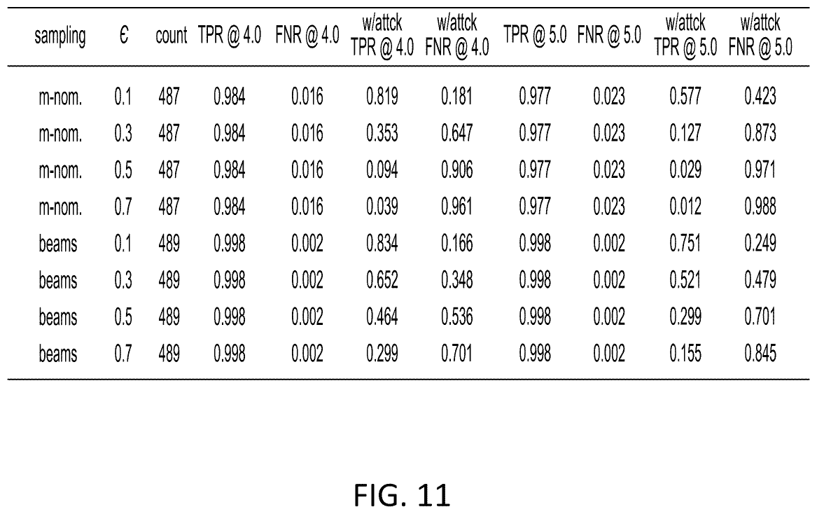

After attacking a set of 500 sequences of length T=200±5 token sequences this way, updated z-scores may be computed and error rates may be tabulated (see FIG. 11 of error rates for watermarked text before and after attack). As illustrated in FIG. 11, the error rates for watermarked text is shown before and after an attack (w/attack) for generations of length T=200±5. For all settings, (δ, γ)=(2.0, 0.5) may be used. Results are shown in FIG. 11 for both multinomial sampling and greedy 8-way beam search. The true positive rates (TPR) and false positive rates (FNR) without the attack are shown for reference, but they may have no dependence on the attack budget, E. For all experiments, no false positives were observed and, thus, FPR=0 and TPR=1.

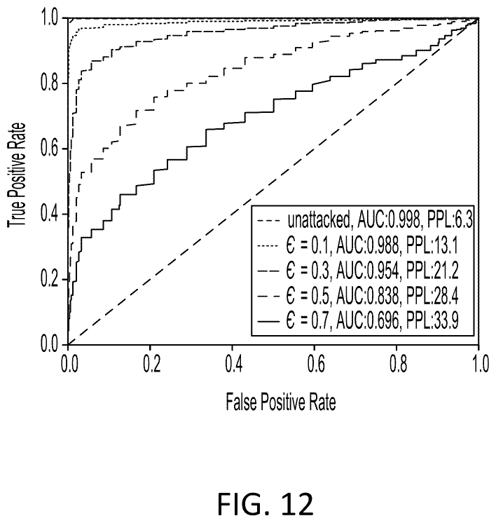

FIG. 12 illustrates an example of ROC curves for watermark detection under attack, according to certain embodiments. As illustrated in FIG. 12, the attack is via the T5 attack described herein with various replacement budgets, ε. The initial, unattacked watermark is a γ=0.5, δ=2.0 soft watermark generated using multinomial sampling. The attack achieves a high level fo watermark degradation, but only at ε=0.3, which costs the attacker an average of ˜15 points of perplexity compared to the PPL of the original watermarked text. While attacking a set of 500 sequences of length T=200±5 token sequences may be effective at increasing the number of red list tokens in the text (FIG. 12), a decrease in watermark strength of 0.01 AUC is measured when ε=0.1. While the watermark removal is more successful at a larger budget of 0.3, the average PPL of attacked sequences may increase by 3× in addition to requiring more model calls.

### Experimental Results

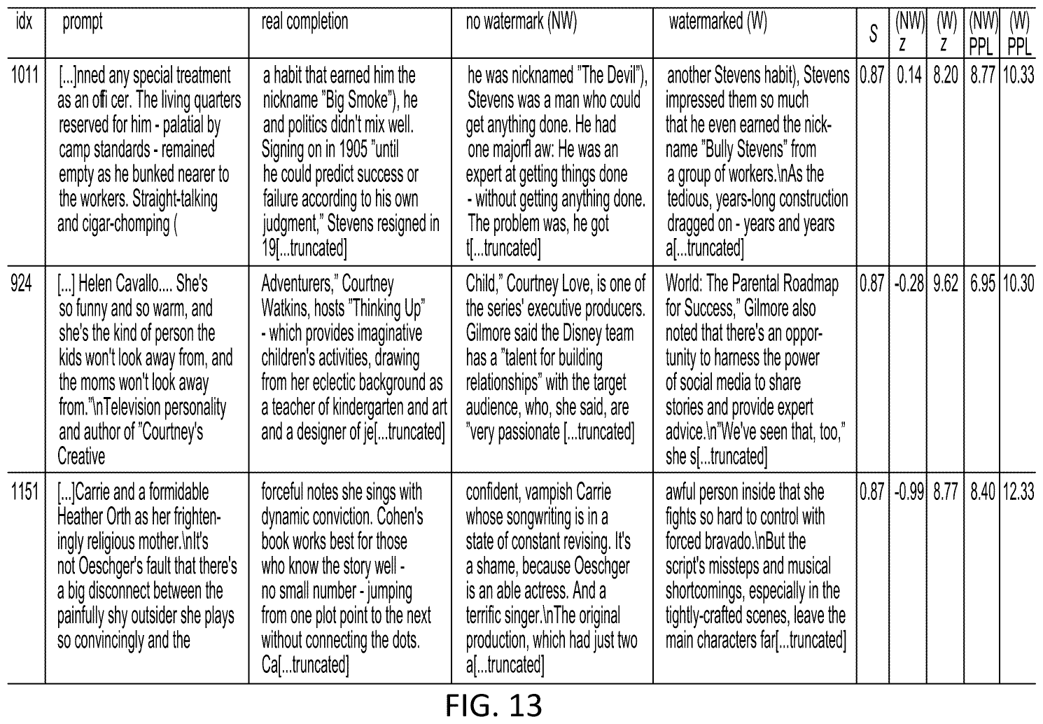

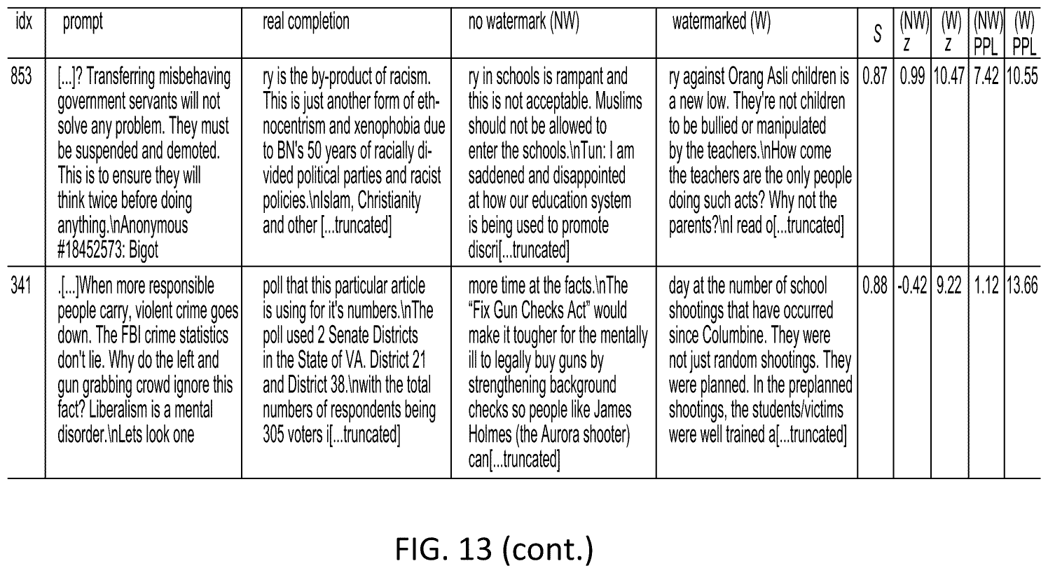

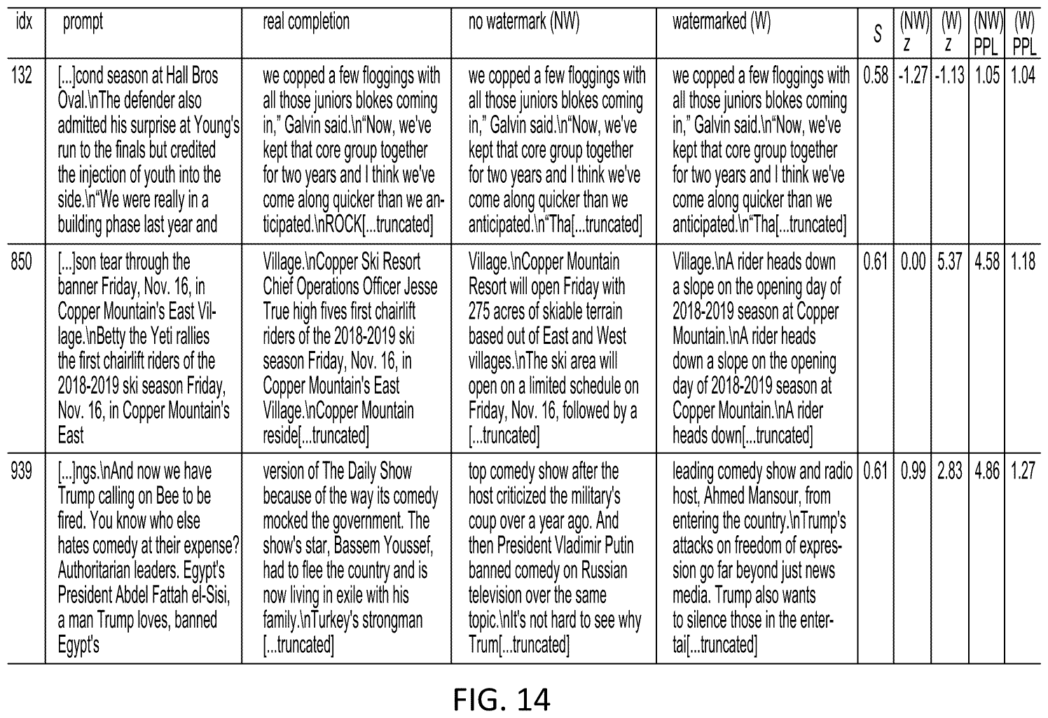

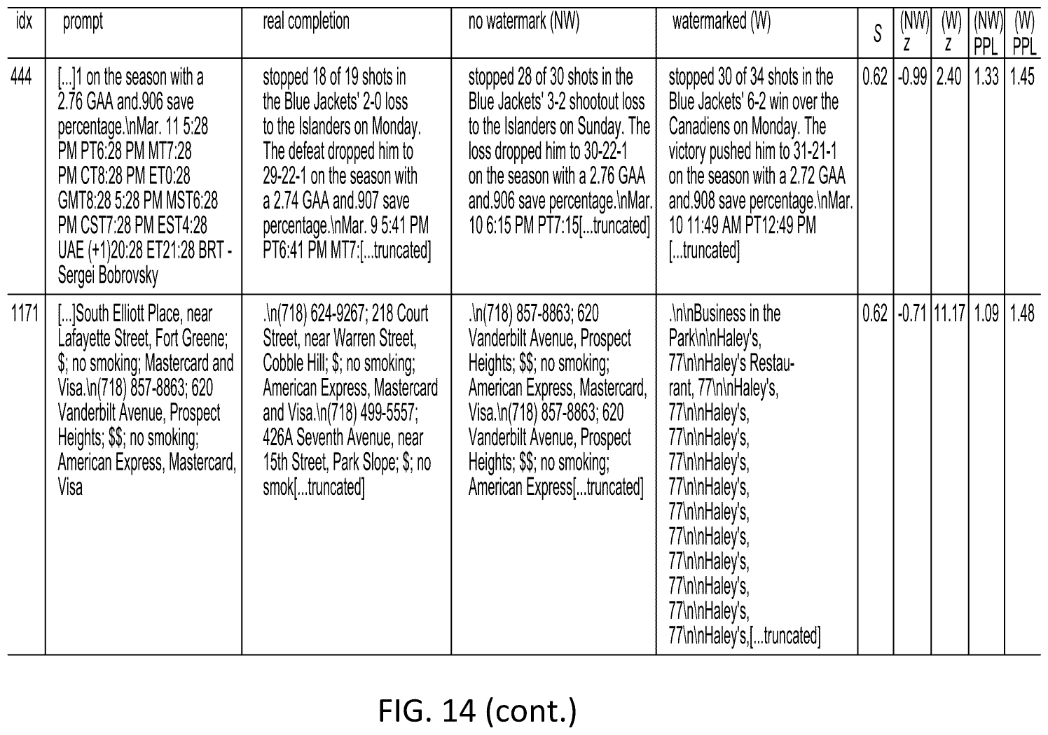

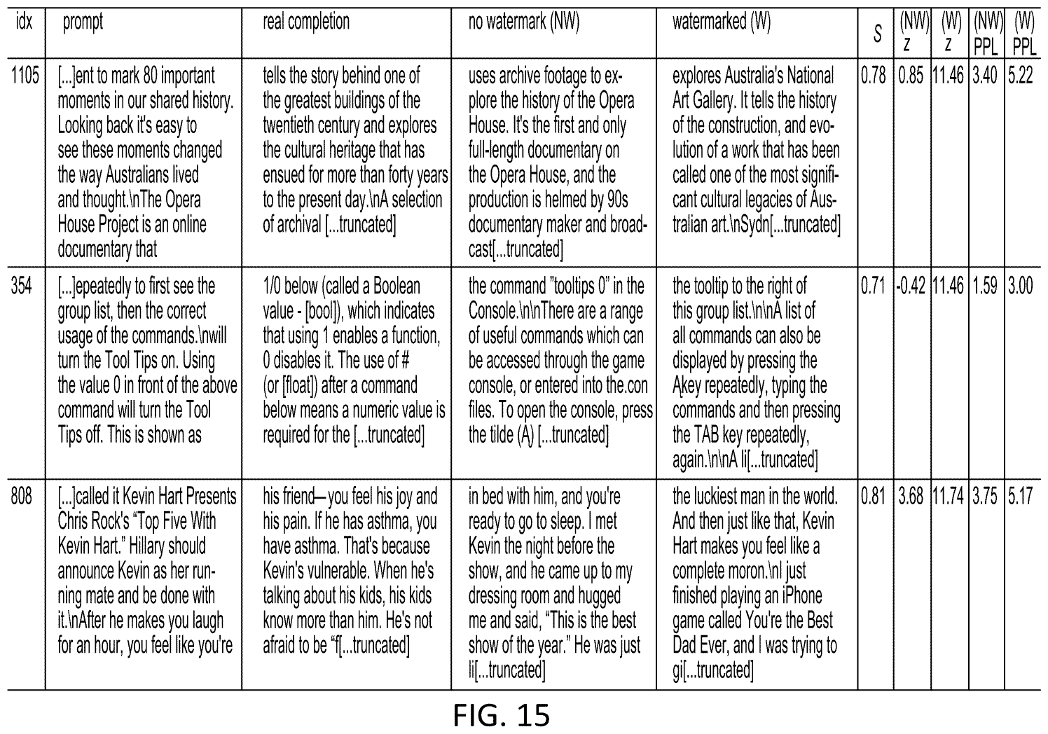

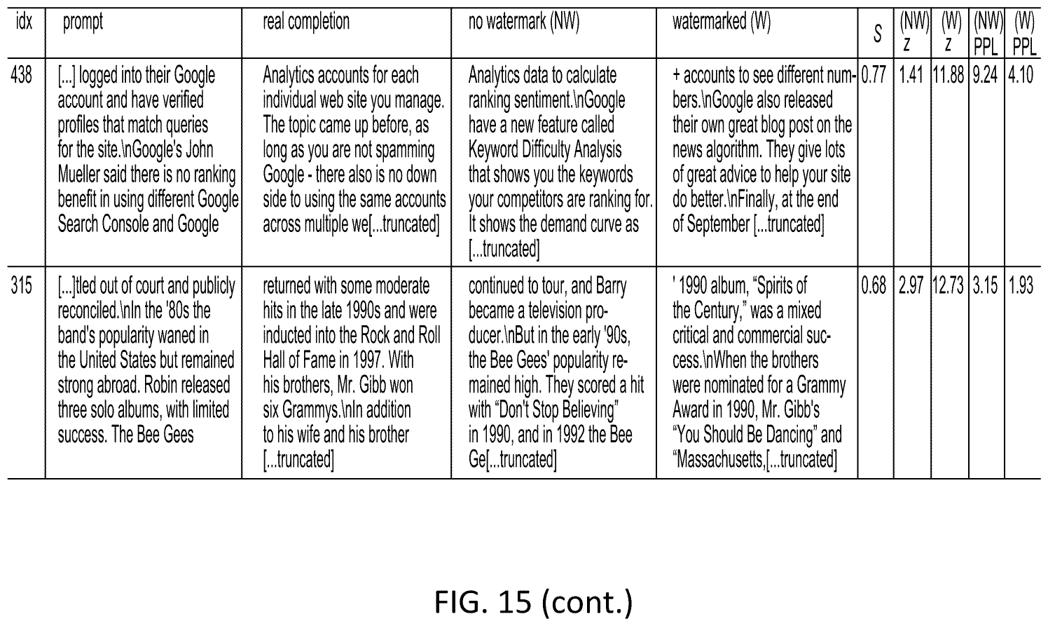

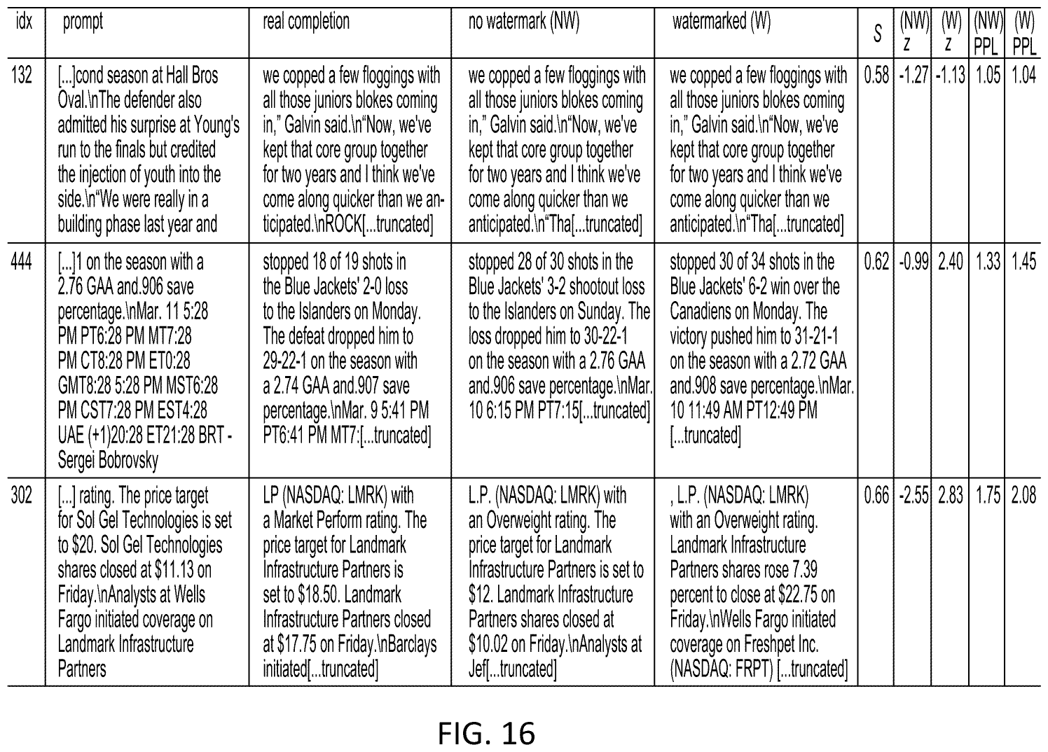

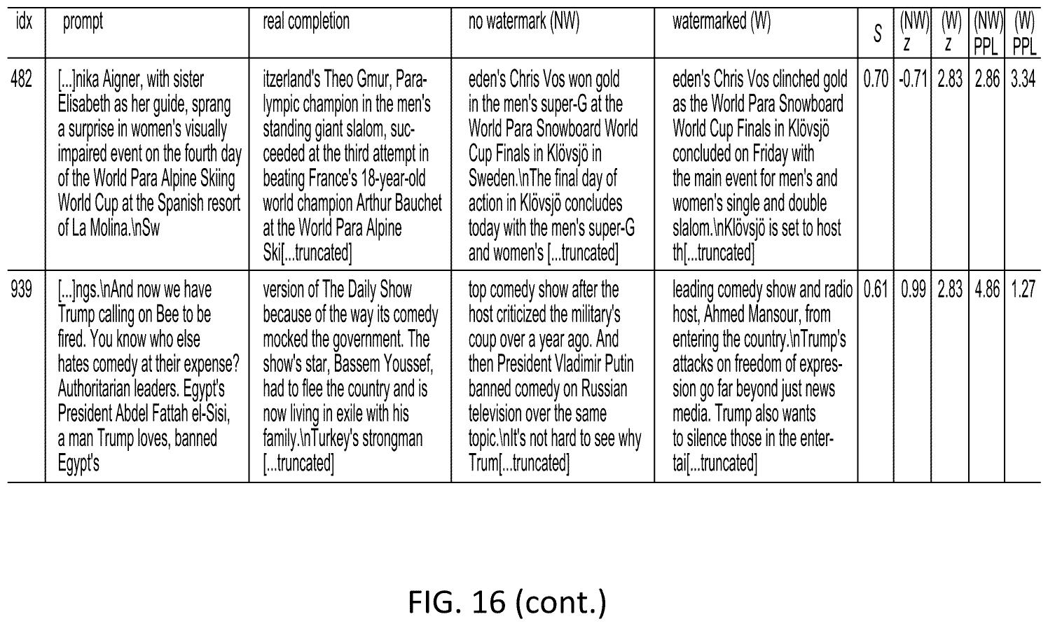

FIG. 13 illustrates a list of high spike entropy examples, according to certain embodiments, and FIG. 14 illustrates a list of low spike entropy examples, according to certain embodiments. Additionally, FIG. 15 illustrates a list of high z-score examples, according to certain embodiments, and FIG. 16 illustrates a list of low z-score examples, according to certain embodiments. As illustrated in FIGS. 13 and 14, certain embodiments may provide a series of representative outputs from different ranges in the sample space for model generations under a soft watermark with parameters δ=2.0, γ=0.5 under the multinomial sampling scheme. To tabulate these outputs, the ˜500 generations collected at this setting may either be sorted by the average spike entropy of the watermarked model's output distribution at generation time, or the measured test statistic, the z-score for that sequence. The top and bottom 5 samples according to these orderings are shown for both entropy (FIGS. 13 and 14) and z-score (FIGS. 15 and 16).

According to certain embodiments, to determine perplexity, the larger, Oracle LM may be fed the original prompt as input, and perplexity may be determined via taking the exponential of the average token-wise loss according to the oracle's next token distribution at every output index. In certain embodiments, the loss may be determined for only the generated tokens produced by either a watermarked or non-watermarked model.

In certain embodiments, the threat model may be defined for the attacks discussed above. As described, attacks may occur when malicious users operate bots/sock-puppets on various platforms such as, for example, social media. Attacks may also occur by trying to fool a CATPCHA, or complete an academic assignment. In certain embodiments, the adversarial behavior may be defined as all efforts by a party that uses machine generated text to remove the watermark. In certain circumstances, a watermark may be on tokens of the generated text (e.g., on its form and style), and not on its semantic content. For instance, a completely new essay written based on an outline or initial draft provided by a LM may not be detected.

As a threat model, certain embodiments may assume two parties; a model owner providing a text generation API, and an attacker attempting to remove the watermark from the API output. The attacker may move second, and may be aware that the API contains a watermark. In public mode, the attacker may be aware of all details of the hashing scheme and initial seed. In private mode, the attacker may be aware of the watermark implementations (e.g., Algorithm 3), but has no knowledge of the key of the pseudo-random function, F. The attacker may attempt to reduce the number of green-listed occurrences in the text, reducing the z-score determined by a defender. In public mode, any party may evaluate the watermark. However, in private mode, only the model owner can evaluate the watermark and provide a text detection API. It may be assumed that this API is rate-limited. Additionally, the attacker may be assumed to have access to other non-watermarked LMs; however, these models are often weaker than the API under attack. The attacker may also be allowed to modify the generated text in any way.

Removal of the watermark may be a trivial task if the LM quality is disregarded—one can simply replace the entire text with random characters. For this reason, attacks that result in a reasonable language quality trade-off for the attacker may be relevant. A defense may therefore also be successful if any watermark removal by the attacker reduces the quality of the generated text to that of generated text achievable using a public model.

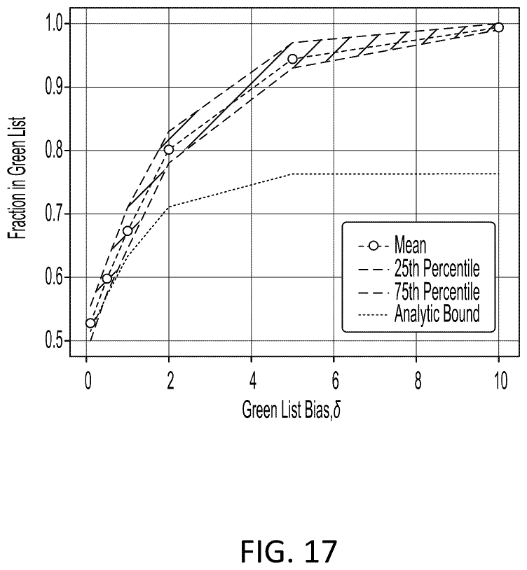

When a multinomial sampler is used, the softmax output may be used with standard temperature hyperparameter temp=0.7. The alignment between the empirical strength of the watermark and the theoretical lower bound for γ=0.5 may be analyzed (see FIG. 17 illustrating an example empirical green list fraction vs bias parameter δ). Through this analysis, it is found that the theoretical bound is quite tight for smaller values of δ, but the theorem under-estimates watermark sensitivity for larger δ.

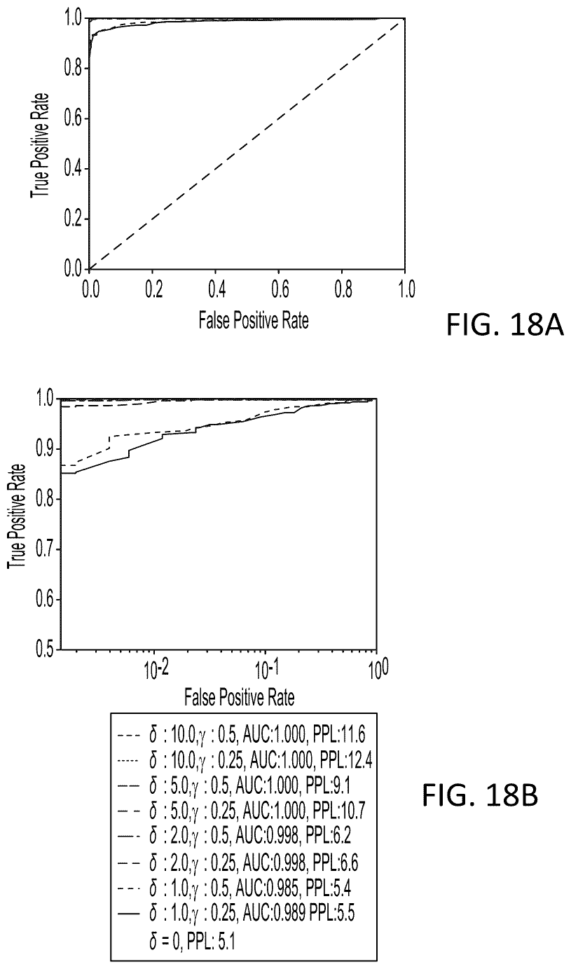

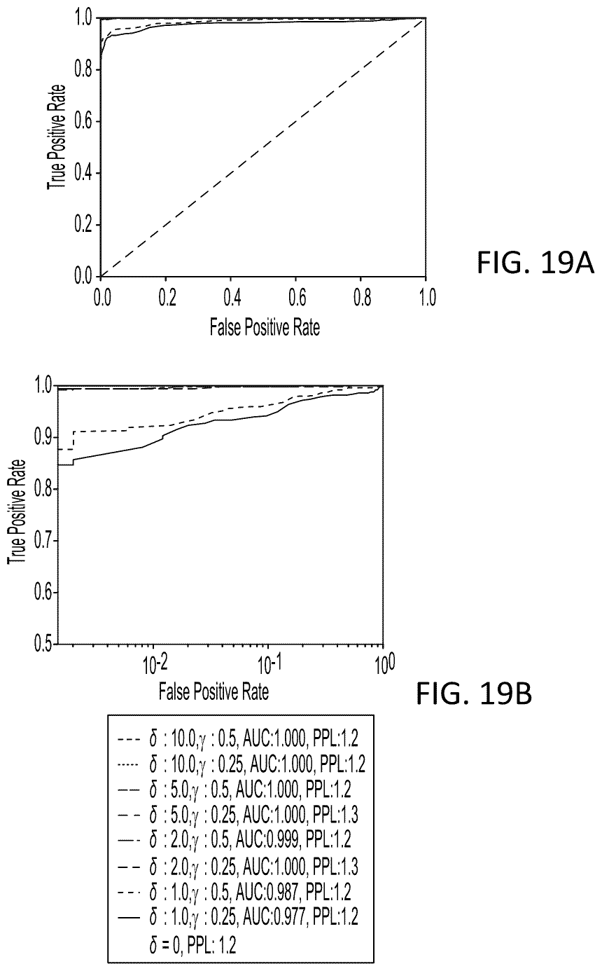

ROC curves for multinomial sampling and greedy decoding with 8-way bema search in the 200 token case are illustrated in FIGS. 18A, 18B and FIGS. 19A, 19B. In particular, FIG. 18A illustrates an ROC curve with AUC values for watermark detection. Curves for several choices of watermark parameters γ and δ are illustrated, and multinomial sampling is used across all settings. FIG. 18B illustrates the same chart as in FIG. 18A, but with different axes to make details visible. The stronger watermarks corresponding to lower γ values and higher δ values may achieve the best error characteristics.

FIG. 19A illustrates an ROC curve with AUC values for watermark detection. The curves for several choices of watermark parameters γ and δ are illustrated—greedy decoding and 8-way beam search may be used to generate tokens in all settings. FIG. 19B illustrates the same chart as in FIG. 19A, but with different axes to make the details visible. Similarly to FIGS. 18A and 18B, higher δ values may achieve stronger performance, but for a given δ value, the beam search may allow the watermark to capture slightly more AUC than the corresponding parameters under the multinomial sampling scheme.

The watermarking in certain embodiments may include variations such as multiple watermarks. For instance, a company may apply multiple watermarks to generated text, taking the union of all red lists at each token. This is a compromise in terms of watermark effectiveness, compared to a single watermark. However, using multiple watermarks may allow for additional flexibility. Additionally, a company may run a public/private watermarking scheme, giving the public access to one of the watermarks to provide transparency and independent verification that text was machine generated. At the same time, the company may keep the second watermark private and test text against both watermarks, to verify cases reported by the public watermark, or again to provide a stronger detection API. Such a setup may be effective in detecting whether an attack took place that attempted to remove the public watermark.

In other embodiments, watermarks may be used selectively in response to malicious activity. For instance, an API owner may turn on watermarking (or dial up its strength considerably via increased δ) only when faced with suspicious API usage by some accounts, for example, if a request appears to be part of malicious activity such as creating synthetic tweets/messages. This would give more leeway to benign API suages, but allow for improved tracing of malicious API utilization.

In some instances, an attacker may be aware that a watermark is present. However, the attacker may also discover this fact by analyzing generated text. Although this would be easy for a hard watermark, some combinations of tokens may never be generated by the model, no matter how strongly they are prompted. For a soft watermark (e.g., with small δ), that may depend on, for example, h=10 tokens via Algorithm 3. The attacker may need to distinguish the modification of green list logits via δ from naturally occurring biases of the LM.

According to certain embodiments, spike entropy may be used to predict how often a watermarked LM will produce a green list token. When the entropy is high, the LM may have a lot of freedom and the model may be expected to use green list tokens aggressively. When the entropy is low, however, the model may be more constrained and more likely to use a red list token.

As an example, a LM may produce a raw (pre-watermark) probability vector p∈(0.1)^{N}. The parameter p may be randomly partitioned into a green list of size γN and a red list of size (1−γ)N for some γ∈(0,1). From the corresponding watermarked distribution by boosting the green list logits by δ, as in equation (4). The parameter α may be defined as α=exp(δ). A token index k may be sampled from the watermarked distribution, and the probability that the token is sampled from the green list may be at least:

$$ℙ [ k ∈ G ] \geq \frac{γα}{1 + ( α - 1 ) γ} S ( p , \frac{( 1 - γ ) ( a - 1 )}{1 + ( α - 1 ) γ} ) .$$

When δ is added to the logits corresponding to the green list words, their probabilities of being sampled are increased. Here, it may be possible to replace the raw probability pₖ for each green list word with the enlarged probability as follows:

$${p}_{k}^{ω} \frac{α {p}_{k}}{{\sum }_{i ∈ R} {p}_{i} + α {\sum }_{i ∈ G} {p}_{i}} ,$$

where G is the set of green list indices and R is the complementary set of red list indices. The sizes of these sets may be denoted as N_{G} and N_{R}, respectively.

To prove the theorem considering watermarked text sequences of T tokens, the size of a randomly chosen green list probability may be bound after it has been enlarged. The proof may include choosing a random entry pₖ and placing it in the green list. Then, the remaining entries in the green list may be randomly sampled. The expected value of a randomly chosen probability from the green list may be written as follows:

$${𝔼}_{k < N} {𝔼}_{G , R} \frac{α {p}_{k}}{{\sum }_{i ∈ R} {p}_{i} + α {\sum }_{i ∈ G} {p}_{i}} , \qquad ( 4 )$$

where the inner expectation is over uniformly random green/red partitions that satisfy k∈G.

With the above expression (4), the inner expectation on the right may be bound. In doing so, consideration of the following may be given:

$${f}_{k} ( p ) = {𝔼}_{G , R} \frac{α {p}_{k}}{{\sum }_{i ∈ R} {p}_{i} + α {\sum }_{i ∈ G} {p}_{i}} ,$$

where G and R are sampled at random from the set of partitions that satisfy k∈G. The value of ƒₖ is invariant to permutations in the order of the indices {pᵢ, i≠k}. For this reason, ƒ(p)= [symbol] _{II}ƒ (IIₚ), where II is a random permutation that leaves pₖ in place. Also, ƒₖ is convex in p₋ₖ. By Jensen's inequality, the following may be obtained:

$$f ( p ) = 𝔼 \text{?} f ( {II}_{p} ) \geq f ( 𝔼 \text{?} {II}_{p} ) .$$

$$\text{?} \text{indicates text missing or illegible when filed}$$

The expectation on the right involves a probability vector p̅ [symbol] [symbol] IIₚ in which

$${\overline{p}}_{i} = \frac{1 - {p}_{0}}{N - 1} for i \neq k .$$

As a result, the following may be obtained:

$$\begin{matrix}{f}_{k} ( p ) \geq {f}_{k} ( \text{?} ) = \frac{α {p}_{k}}{\begin{matrix}{N}_{R} ( 1 - {p}_{k} ) / ( N - 1 ) + \\ α ( {N}_{G} - 1 ) ( 1 - p \text{?} ) / ( N - 1 ) + α p \text{?}\end{matrix}} & ( 5 ) \\ = \frac{α {p}_{k} ( N - 1 )}{( {N}_{R} + α {N}_{G} - α ) ( 1 - {p}_{k} ) + α p \text{?} ( N - 1 )} & ( 6 ) \\ = \frac{α {p}_{k} ( N - 1 )}{{N}_{R} + α {N}_{G} - α + ( α N - {N}_{R} - α {N}_{G} ) {p}_{k}} & ( 7 ) \\ = {p}_{k} \frac{α N - α}{{N}_{R} + α {N}_{G} - α + ( α {N}_{R} - {N}_{R} ) {p}_{k}} & ( 8 ) \\ \geq {p}_{k} \frac{α N}{{N}_{R} + α {N}_{G} + ( α {N}_{R} - {N}_{R} ) {p}_{k}} & ( 9 )\end{matrix}$$

$$\text{?} \text{indicates text missing or illegible when filed}$$

In the last step (9), the numerator is larger than the denominator and, thus, adding a to the numerator and denominator results in a small decrease in the bound. Additionally, the fraction on the right side of (9) is strictly greater than 1 for any value of pₖ∈(o, 1) and α≥1. For this reason, the bound is never vacuous, as ƒₖ(p)>pₖ. Now let γ=N_{G}/N, which simplifies the notation f the intermediate result to:

$${f}_{k} ( p ) \geq \frac{α {p}_{k}}{( 1 - γ ) + αγ + ( α - 1 ) ( 1 - γ ) {p}_{k}} . \qquad ( 10 )$$

Using the expression (1) to simplify (4), the following is obtained:

$${𝔼}_{k < N} {𝔼}_{G , R} \frac{α {p}_{k}}{{\sum }_{i ∈ R} {p}_{i} + α {\sum }_{i ∈ G} {p}_{i}} = {𝔼}_{k < N} {f}_{k} ( p ) \geq \frac{α {N}^{- 1}}{1 + ( α - 1 ) γ} S ( p , \frac{( 1 - γ ) ( α - 1 )}{1 + ( α - 1 ) γ} ) .$$

The probability of sampling a token from the green list is exactly N_{G} times larger than an average green list probability. The probability of sampling from the green list may, thus, be given by:

$${N}_{G} {𝔼}_{k < N} {𝔼}_{G , R} \frac{α {p}_{k}}{{\sum }_{i ∈ R} {p}_{i} + α {\sum }_{i ∈ G} {p}_{i}} \geq \frac{γ α}{1 + ( α - 1 ) γ} S ( p , \frac{( 1 - γ ) ( α - 1 )}{1 + ( α - 1 ) γ} ) .$$

From the above, it may be observed that the bound in Lemma E.1 is never vacuous. The probability of choosing a token from the green list may be trivially at least γ, and for any combination of finite logits, the bound in Lemma E.1 may strictly be greater than this trivial lower bound. Using this lemma, it may be possible to prove the main theorem.

For example, Lemma E.1 may bound the probability of a single token being in the green list. To determine the total number of green list tokens in the sequence, this bound may be summed over all the tokens to obtain:

$$𝔼 {\vert s \vert}_{G} = {\sum }_{t} \frac{γα}{1 + ( α - 1 ) γ} {S}^{t} = T {𝔼}_{t} \frac{γα}{1 + ( α - 1 ) γ} {S}^{t} \geq \frac{γα T}{1 + ( α - 1 ) γ} S \text{?} .$$

$$\text{?} \text{indicates text missing or illegible when filed}$$

where S^{(t)} represents the entropy of the distribution of token t.

To obtain the variance bound, the variance of a Bernoulli random variable may include success probability p as p(1−p). The expected number of green list tokens may be a sum of independent random Bernoulli variables, each representing one token. These variables may not be identically distributed, but rather each may have a success probability given by Lemma E.1. The variance of the sum may be the sum of the variances, which is:

$$Var {\vert s \vert}_{G} = \sum \text{?} \frac{γα {S}^{t}}{1 + ( α - 1 ) γ} ( 1 - \frac{γα {S}^{t}}{1 + ( α - 1 ) γ} ) = T 𝔼 \text{?} \frac{γα {S}^{t}}{1 + ( α - 1 ) γ} ( 1 - \frac{γα {S}^{t}}{1 + ( α - 1 ) γ} ) .$$

$$\text{?} \text{indicates text missing or illegible when filed}$$

The expectation on the right may include a concave function of S^{t}. By Jensen's inequality, it may be possible to pass the expectation inside the function to obtain:

$$Var {\vert s \vert}_{G} \leq T \frac{γα {𝔼}_{t} S \text{?}}{1 + ( α - 1 ) γ} ( 1 - \frac{γα {𝔼}_{t} S \text{?}}{1 + ( α - 1 ) γ} ) .$$

$$\text{?} \text{indicates text missing or illegible when filed}$$

It may be noted that the probability of a token being in the green list may always be at least γ, regardless of the distribution coming from the LM. Lemma E.1 may never be vacuous, and the success probability predicted by the Lemma may be at least γ. If γ≥0.5, then the variance of each Bernoulli trial is at most the variance of a Bernoulli trial with success probability γ, which may be given by γ(1−γ). Plugging this into the bound results in:

$$Var {\vert s \vert}_{G} \leq T \frac{γα {𝔼}_{t} S \text{?}}{1 + ( α - 1 ) γ} ( 1 - \frac{γα {𝔼}_{t} S \text{?}}{1 + ( α - 1 ) γ} ) \leq T γ ( 1 - γ ) .$$

$$\text{?} \text{indicates text missing or illegible when filed}$$

According to certain embodiments, in proving the theorem regarding the impact on quality of the generated text, the probability of sampling token k from the modified distribution may be expressed as:

$${\hat{p}}_{k} = {𝔼}_{G , R} \frac{α {p}_{k}}{{\sum }_{i ∈ R} {p}_{i} + α {\sum }_{i ∈ G} {p}_{i}} , \qquad ( 11 )$$

where G and R are random partitions of the vocabulary indices. This expected value may be written as the sum of a contribution from the case in which k∈G, and one in which, ∈R. By doing so, the following may be obtained:

$${𝔼}_{G , R} \frac{α {p}_{k}}{{\sum }_{i ∈ R} {p}_{i} + α {\sum }_{i ∈ G} {p}_{i}} = {𝔼}_{G , R} \text{?} \frac{α {p}_{k}}{{\sum }_{i ∈ R} {p}_{i} + α {\sum }_{i ∈ G} {p}_{i}} \qquad ( 12 )$$

$$+ {𝔼}_{G , R} \text{?} \frac{α {p}_{k}}{{\sum }_{i ∈ R} {p}_{i} + α {\sum }_{i ∈ G} {p}_{i}} \leq γα {p}_{k} + ( 1 - γ ) {p}_{k} = ( 1 + ( α - 1 ) γ ) {p}_{k} . \qquad ( 13 )$$

$$\text{?} \text{indicates text missing or illegible when filed}$$

$${𝔼}_{G , R} {\sum }_{k} {\hat{p}}_{k} \text{?} ln ( {p}_{k} \text{?} ) = {\sum }_{k} {𝔼}_{G , R} {\hat{p}}_{k} \text{?} ln ( {p}_{k} \text{?} ) \leq ( 1 + ( α - 1 ) γ ) p \text{?} .$$

$$\text{?} \text{indicates text missing or illegible when filed}$$

The expected perplexity may then be given by:

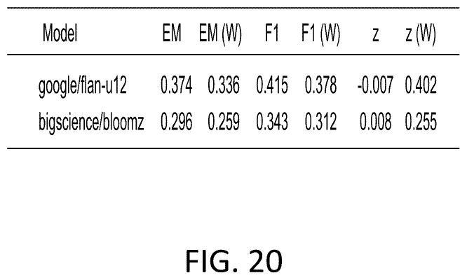

The table in FIG. 11 relates to performance measured using standard metrics Exact Match (EM) and whitespace-tokenized F1 score against each question's answer alias list. “(W)” indicates generation with the watermark, and the data is made up of 50,000 samples from the validation split of the unfiltered version of TriviaQA dataset. Questions are posed to the model in a zero-shot manner with no in-context demonstrations. A prompt template may be used: ƒ′ The following is a trivia question with a single correct factual answer. Please provide the answer to the question.\n\nQuestion {q}\n\nAnswer:”. Generation may be performed using greedy coding to maximize the baseline/unwatermarked performance (see FIG. 20 illustrating a table of performance metrics, according to certain embodiments).

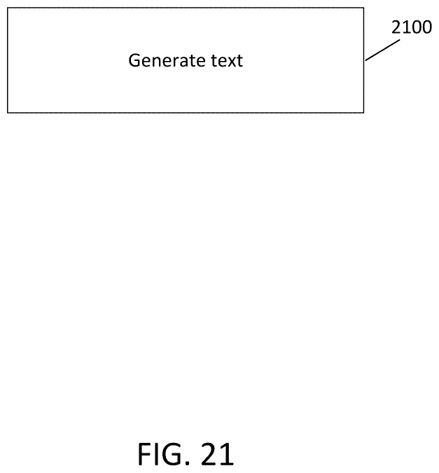

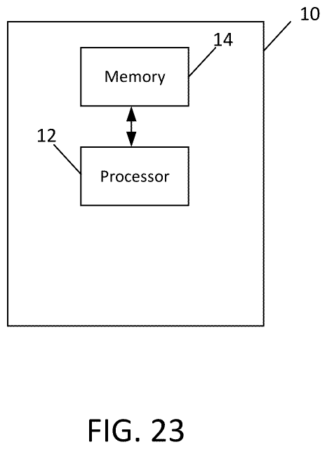

FIG. 21 illustrates an example flow diagram of a method, according to certain example embodiments. In certain example embodiments, the flow diagram of FIG. 21 may be performed by a system that includes a computer apparatus, computer system, network, neural network, apparatus, or other similar device(s). According to certain embodiments, each of these apparatuses of the system may be represented by, for example, an apparatus similar to apparatus 10 illustrated in FIG. 23.

According to one example embodiment, the method of FIG. 21 may include, at 2100, generating text comprising modifying a sampling process of the LLM by assigning pseudo-random scores to words of the text. The value of the pseudo-random scores may influence the likelihood of the words to be sampled.

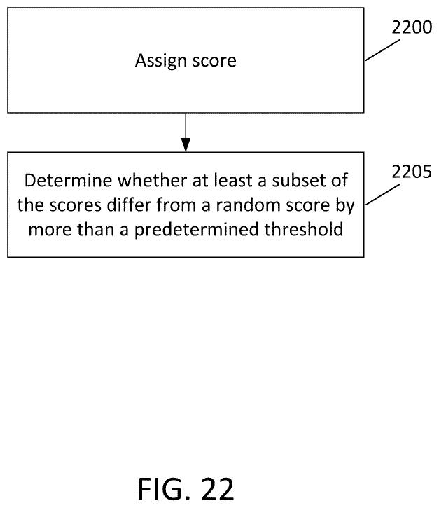

FIG. 22 illustrates an example flow diagram of a method, according to certain example embodiments. In certain example embodiments, the flow diagram of FIG. 22 may be performed by a system that includes a computer apparatus, computer system, network, neural network, apparatus, or other similar device(s). According to certain embodiments, each of these apparatuses of the system may be represented by, for example, an apparatus similar to apparatus 10 illustrated in FIG. 23.

According to one example embodiment, the method of FIG. 22 may include, at 2200, assigning a score to at least one word in a text.

At 2205, the method may further include determining whether at least a subset of the scores differ from a random score by more than a predetermined threshold.

In certain example embodiments, the predetermined threshold, and a likelihood that the assigned scores exceed the predetermined threshold, may be inversely related, and watermarked text is likely to exceed the threshold, while non-watermarked text is unlikely to exceed the threshold.

In some example embodiments, the method may further include upon determining that the assigned scores exceed the predetermined threshold, determining that the text is watermarked.

In various example embodiments, the method may further include upon determining that the text was generated by a watermarked process, generating at least one indication of at least one of the authorship or authenticity of the text.

In certain example embodiments, the distribution of the assigned scores may differ from the distribution of corresponding random scores.

In some example embodiments, the determination that a predetermined watermarking process generated the text is based upon a p-value.

In various example embodiments, the determination that a predetermined watermarking process generated the text may be based upon a first list of size γN, and a second list of size (1−γ)N for some γ∈(0,1).

In certain example embodiments, the determination that a predetermined watermarking process generated the text may be based upon a hypothesis test.

FIG. 23 illustrates an apparatus 10 according to an example embodiment. Although only one apparatus is illustrated in FIG. 23, the apparatus may represent multiple apparatus as part of a system or network. For example, in certain embodiments, apparatus 10 may be a computer apparatus that operate individually or together as a system.

In some embodiments, the functionality of any of the methods, processes, algorithms or flow charts described herein may be implemented by software and/or computer program code or portions of code stored in memory or other computer readable or tangible media, and executed by a processor.

For example, in some embodiments, apparatus 10 may include one or more processors, one or more computer-readable storage medium (for example, memory, storage, or the like), one or more radio access components (for example, a modem, a transceiver, or the like), and/or a user interface. It should be noted that one of ordinary skill in the art would understand that apparatus 10 may include components or features not shown in FIG. 23.

As illustrated in the example of FIG. 23, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 23, multiple processors may be utilized according to other embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-22.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-22.

Additionally or alternatively, in some embodiments, apparatus 10 may include an input and/or output device (I/O device). In certain embodiments, apparatus 10 may further include a user interface, such as a graphical user interface or touchscreen.

In certain embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, processor 12 and memory 14 may be included in or may form a part of processing circuitry or control circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware.

According to certain embodiments, apparatus 10 may be controlled by memory 14 and processor 12 to generate text comprising modifying a sampling process of the LLM by assigning pseudo-random scores to words of the text. The pseudo-random score of a word is related to a sampling likelihood of the word.

Certain example embodiments may be directed to an apparatus that includes means for generating text comprising modifying a sampling process of the LLM by assigning pseudo-random scores to words of the text. The pseudo-random score of a word is related to a sampling likelihood of the word.

Certain embodiments described herein provide several technical improvements, enhancements, and/or advantages. In some embodiments, it may be possible to provide spike entropy to quantify token distribution spread. This metric provides a way to measure the impact of watermarking on the token distribution, offering theoretical bounds on the expected number of green list tokens and the perplexity increase due to watermarking. Other embodiments may provide a private watermarking system that uses a secret key and PRF to generate red lists. The secret key and PRF may be used to dynamically generate forbidden token lists which enhances security by making it difficult for attackers to reverse-engineer the watermarking rules. Furthermore, some example embodiments may assign or add watermarking to text, enabling the ability to determine the origin and/or authenticity of the text. As a result, various example embodiments are directed to improvements in digital watermarks by enabling verification and validity of digital signals.

In further embodiments, it may be possible to provide a soft watermarking procedure that adds a constant δ to the logits of permitted tokens. As such, it may be possible to subtly bias the LM's output towards certain tokens without prohibiting others, thereby maintaining text quality while embedding a detectable watermark. According to some embodiments, a detection method may be provided that operates without access to the LM or its API. For example, the system may enable watermark detection using only the generated text, without requiring any access to the model's parameters or API.

According to other embodiments, a comprehensive analysis of potential attacks and corresponding defenses in LLM watermarking may be performed. The detailed examination of attacks such as paraphrasing, tokenization, manipulation, homoglyph substitution, zero-width character insertion, and generative attacks, along with defense-like text normalization and instruction finetuning, offers a unique framework for evaluating and improving watermark robustness.

The framework for watermarking LLMs of certain embodiments described herein may have a variety of applicability. For example, the framework may be applicable in detection of AI-generated disinformation on social media platforms by enabling platforms to identify and filter out AI-generated disinformation. As such, it may be possible to prevent the spread of misleading content.

Other embodiments of the framework described herein may be applicable in academic plagiarism detection. For example, educational institutions may detect AI-generated essays or assignments, and maintain academic integrity by identifying unoriginal student submissions. Additional embodiments may be applicable in preventing synthetic data proliferation in training datasets where data curators can filter out AI-generated text from training data, ensuring quality and preventing model degradation due to synthetic content. Further embodiments may be applicable in tracing malicious content generation such as providing law enforcement with the capability of tracing harmful or illegal content back to unauthorized AI usage, aiding in criminal investigations. Additional embodiments may be appliable in content moderation for publishing platforms where publishers can detect and manage AI-generated content submissions, and maintain standards and authenticity of published material. Further embodiments may be applicable in intellectual property protection for AI models, which may enable companies to protect their AI models by embedding watermarks, detecting unauthorized use of their LM's outputs.

In other embodiments, it may be possible to provide strategies that are simultaneously minimally restrictive to a LM, leverage the LMs own understanding of natural text, require no usage of the LM to decode the watermark, and can be theoretically analyzed and validated.

In further embodiments, it may be possible to provide a watermark that has a number of beneficial properties that make it a practical choice during implementation. For instance, the watermark may be computationally simple to verify without access to the underlying model, false positive detections are statistically improbable, and the watermark degrades gracefully under attack. Further, certain embodiments of watermarking can be retro-fitted to any existing model that generates text via sampling from a next token distribution, without retraining.

In other embodiments, the z-statistic used to detect the watermark may depend only on the green list size parameter γ and the hash function for generating green lists. There is no dependence on δ choices or green list enforcement rules for different kinds of text (e.g., prose vs code, or small vs large models) while using the same downstream watermark detector. It may also be possible to change a proprietary implementation of the watermarked sampling algorithm without any need to change the detector. Furthermore, the watermarking method of certain embodiments may be turned on only in certain contexts, for example, when a specific user seems to exhibit suspicious behavior.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware or circuitry included in an apparatus (e.g., apparatus 10), for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an example embodiment, an apparatus, such as a device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

We claim:

1. A method for generating a watermarked output of a large language model (LLM), comprising:
generating text comprising modifying a sampling process of the LLM by assigning pseudo-random scores to words of the text, wherein
the pseudo-random score of a word is related to a sampling likelihood of the word.

2. The method of claim 1, wherein the value of the pseudo-random scores influence the likelihood of the words to be sampled.

3. A method for detecting watermarked output of a large language model (LLM), comprising:
assigning a score to at least one word in a text; and
determining whether at least a subset of the scores differ from a random score by more than a predetermined threshold.

4. The method of claim 3, wherein the predetermined threshold, and a likelihood that the assigned scores exceed the predetermined threshold, are inversely related, and watermarked text is likely to exceed the threshold, while non-watermarked text is unlikely to exceed the threshold.

5. The method of claim 4, further comprising:
upon determining that the assigned scores exceed the predetermined threshold, determining that the text is watermarked.

6. The method of claim 4, further comprising:
upon determining that the text was generated by a watermarked process, generating at least one indication of at least one of the authorship or authenticity of the text.

7. The method of claim 3, wherein the distribution of the assigned scores differ from the distribution of corresponding random scores.

8. The method of claim 4, wherein the determination that a predetermined watermarking process generated the text is based upon a p-value.

9. The method of claim 4, wherein the determination that a predetermined watermarking process generated the text is based upon a first list of size γN, and a second list of size (1−γ)N for some γ∈(0,1).

10. The method of claim 3, wherein the determination that a predetermined watermarking process generated the text is based upon a hypothesis test.

11. An apparatus, comprising:
at least one processor; and
at least one memory including computer program code which, when executed by the at least one processor, cause the apparatus to at least:
assign a score to at least one word in a text; and
determine whether at least a subset of the scores differ from a random score by more than a predetermined threshold.

12. The apparatus of claim 11, wherein the predetermined threshold, and a likelihood that the assigned scores exceed the predetermined threshold, are inversely related, and watermarked text is likely to exceed the threshold, while non-watermarked text is unlikely to exceed the threshold.

13. The apparatus of claim 12, wherein the at least one memory storing the instructions, when executed by the at least one processor, further cause the apparatus at least to:
upon determining that the assigned scores exceed the predetermined threshold, determine that the text is watermarked.

14. The apparatus of claim 12, wherein the at least one memory storing the instructions, when executed by the at least one processor, further cause the apparatus at least to:
upon determining that the text was generated by a watermarked process, generate at least one indication of at least one of the authorship or authenticity of the text.

15. The apparatus of claim 11, wherein the distribution of the assigned scores differ from the distribution of corresponding random scores.

16. The apparatus of claim 12, wherein the determination that a predetermined watermarking process generated the text is based upon a p-value.

17. The apparatus of claim 12, wherein the determination that a predetermined watermarking process generated the text is based upon a first list of size γN, and a second list of size (1−γ)N for some γ∈(0,1).

18. The apparatus of claim 11, wherein the determination that a predetermined watermarking process generated the text is based upon a hypothesis test.
